(19) United States
(12) Patent Application Publication
(10) Pub. No.: US 2023/0160845 A1
(43) Pub. Date: May 25, 2023

(54) Detection of contamination of fluids

(71) Applicant: Smokeless.World GMBH, Grünwald (DE)

(72) Inventors: Daniel Kilger, München (DE); Patrick Müller, Heiningen (DE); Michael Sedlmeier, München (DE)

(21) Appl. No.: 17/917,735

(22) PCT Filed: Mar. 24, 2021
(86) PCT No.: PCT/EP2021/057636

§ 371 Date: Oct. 7, 2022

(30) Foreign Application Priority Data
Apr. 8, 2020 (EP) 20168651.6

(51) Int. Cl. G01N 27/06; A24F 40/53

(52) U.S. Cl. CPC G01N 27/06; A24F 40/53

(57) ABSTRACT

A method for detecting contamination of a fluid in a fluid container includes providing a reference data set related to a reference composition of the fluid, generating a measured data set related to an actual composition of the fluid in the fluid container, a processing unit comparing the reference data set with the measured data set, and determining whether the fluid is contaminated based on the comparison.

### FIELD

The present invention generally relates to the detection of contamination of fluids. More particularly, the present invention relates to the detection of contamination of an inhaling composition in an inhaler, such as, a portable inhaler or more specifically an e-cigarette.

### INTRODUCTION

An electronic cigarette or e-cigarette is a handheld electronic device that can simulate the feeling of smoking. Electronic cigarettes are also known as e-cigarettes (e-cigs, EC), electronic nicotine delivery systems (ENDS), electronic non-nicotine delivery systems (ENNDS), electronic smoking devices (ESDs), personal vaporizers (PVs). They are handheld devices, often made to look like conventional cigarettes and used in a similar way.

E-cigarettes operate by heating a liquid to generate an aerosol, commonly called a “vapor”, that the user inhales. The liquid in the e-cigarette, called e-liquid, or e-juice, is usually made of propylene glycol, glycerin, water, flavorings and nicotine. However, not all e-liquids contain nicotine. Furthermore, different e-liquids may contain different concentrations of nicotine. The majority of toxic chemicals found in tobacco smoke is typically absent in e-cigarette aerosol. Those present should usually be below 1% of the corresponding levels in tobacco smoke. For example, the aerosol can contain toxicants and traces of heavy metals and potentially harmful chemicals not found in tobacco smoke. Nevertheless, these typically are at levels permissible in inhalation medicines or by safety standards.

There are three main types of e-cigarettes: cigalikes, looking like cigarettes; eGos, bigger than cigalikes with refillable liquid tanks; and mods, assembled from basic parts or by altering existing products. As the e-cigarette industry continues to evolve, new products are quickly developed and brought to market. First generation of e-cigarettes tend to look like tobacco cigarettes and is typically referred to as cigalikes. Most cigalikes look like cigarettes but there is some variation in size. A traditional cigarette is smooth and light while a cigalike is rigid and slightly heavier. Second generation of e-cigarettes have a typically larger overall size and look less like traditional tobacco cigarettes. Third generation of e-cigarettes include mechanical mods and variable voltage devices. The fourth generation includes sub ohm tanks and temperature control devices.

The main components of an e-cigarette are a mouthpiece, a cartridge (tank), a heating element/atomizer and a battery. The power source is the biggest component of an e-cigarette, which is frequently a rechargeable lithium-ion battery. The atomizer, also referred to as a vaporizer, typically comprise a heating element and a wicking material. The heating element, typically a coil, generates heat when an electric current is passed through it. The wicking material is submerged in the e-liquid and is brought into contact with the heating element, typically, by passing the wick through a coil. Thus, the wicking material draws liquid onto the coil. When activated, the heating element atomizes the liquid solution. The e-liquid reaches a temperature of roughly 100-250° C. within a chamber to create an aerosolized vapor, which can be inhaled. The aerosol provides a flavor and feel similar to tobacco smoking.

E-cigarettes may be used with other substances and cartridges can potentially be filled with e-liquid containing substances other than nicotine, thus serving as a new way to deliver other psychoactive drugs, for example cannabis. Cannabis, also known as marijuana among other names, is a psychoactive drug from the Cannabis plant or synthesized used for medical or recreational purposes. The main psychoactive part of cannabis is tetrahydrocannabinol, one of 483 known compounds in the plant, including at least 65 other cannabinoids. Cannabis can be used by smoking, vaporizing, within food, or as an extract. The term cannabis is intended to cover tetrahydrocannabinol (THC), cannabidiol (CBD), terpenes etc. The emergence of e-cigarettes has given cannabis smokers a new method of inhaling cannabinoids. E-cigarettes, also known as vape pens, cartridges and pens, differ from traditional marijuana cigarettes in several respects. It is assumed that vaporizing cannabinoids at lower temperatures is safer because it produces smaller amounts of toxic substances than the hot combustion of a marijuana cigarette. Recreational cannabis users can discreetly “vape” deodorized cannabis extracts with minimal annoyance to the people around them. While cannabis is not readily soluble in the liquid used for e-cigs, recipes containing synthetic cannabinoids which are soluble may be found.

E-liquid is the mixture used in vapor products such as e-cigarettes and generally consists of propylene glycol, glycerin, water, nicotine, and flavorings. Typically, the e-liquid contains 95% propylene glycol and glycerin. However, the other components in the mixture may vary and more than 8000 flavors can be used. Quality of an e-liquid may depend on the quality of the nicotine, accuracy of content, quality of diluents, hygiene of manufacturing environment, isolations from environment outside the manufacturing (e.g. during transportation or shelf life), quality of container and the like. Depending on the quality some e-liquids may be hazardous to the health of the user. This is reported, for example, in the following study:
Putzhammer R, Doppler C, Jakschitz T, Heinz K, Forste J, et al. (2016) Vapours of US and EU Market Leader Electronic Cigarette Brands and Liquids Are Cytotoxic for Human Vascular Endothelial Cells. PLOS ONE 11(6): e0157337. https://doi.org/10.1371/journal.pone.0157337.

Putzhammer et. al. reported that vapors generated from different liquids using the same e-cigarette show substantial differences, pointing to the liquids as an important source for toxicity. Furthermore, they showed that some e-cigarette vapor extracts showed high cytotoxicity, inhibition of cell proliferation, and alterations in cell morphology, which in some cases were even comparable to conventional high-nicotine cigarettes.

US 2014/0014126 A1 teaches an electronic cigarette (“e-Cig”) that may include functionality for monitoring and controlling the thermal properties of the e-Cig. The system and method described therein may monitor a temperature based on a resistor (i.e. hot wire) near the wick and model the thermal cycle of an e-Cig. The model can be used for controlling the temperature of the e-Cig and preventing burning. The temperature control may dictate optimal conditions for atomization and smoke generation in an e-Cig while avoiding hotspots and burning to the atomizer or cartomizer.

To reduce the risk of damaging the health of an e-cigarette user, standards dealing with the quality of e-liquids have been created. Such standards are for example, published by the American E-liquid Manufacturing Standards Association (AEMSA).

However, the cartridges containing the e-liquid of an e-cigarette can be replaced or refilled. This may make it particularly challenging to ensure that the liquid in the replaced or refilled cartridge conforms to regulations and standards, even more so when considering the large number of e-liquids that currently exist. As such, the risk of the e-liquid comprising contaminants or not conforming with regulations and standards is prevalent.

Thus, although previous e-cigarettes may be advantageous to some extent particularly compared to conventional cigarettes, they may have certain drawbacks and limitations. They lack a control mechanism for protecting the user against contaminated e-liquids. Thus, to reduce the risk of damaging the health of the user and increase the satisfaction in the overall user experience, new technologies and methodologies are required.

### SUMMARY

It is an object of the present invention to overcome or at least alleviate the shortcomings of the prior art. In particular, it is one of the objects of the present invention to provide a technology for detecting contamination of an inhaling composition in an inhaler.

A first aspect of the present invention relates to a method for detecting contamination of a fluid in a fluid container.

The method comprises providing a reference data set related to a reference composition of the fluid. The reference composition of a fluid can indicate the composition that said fluid is intended, expected and/or required to be composed of. That is, a non-contaminated fluid can be composed according to the reference composition.

In a further step, the method comprises generating a measured data set related to an actual composition of the fluid. The actual composition of a fluid can indicate the composition that said fluid is actually composed of. It will be noted that in case the fluid is contaminated, the actual composition of the fluid is different from the reference composition of the fluid.

The method further comprises comparing the reference data set with the measured data set. This comparison is carried out by a processing unit. Based on the comparison, the method comprises determining whether the fluid in the fluid container is contaminated.

That is, first a reference data set can be provided. The reference data set can indicate a reference composition of the fluid. In other words, the reference data can indicate an intended or expected composition of the fluid in the fluid container. Put simply, the reference data set can indicate the composition of a non-contaminated fluid. Then, a measurement of the fluid in the fluid container can be performed for detecting whether the fluid in the fluid container is contaminated. Based on the measurement, the measured data set can be generated. The measurement data set can indicate the actual composition of the fluid. If the fluid in the fluid container is not contaminated than the composition of the fluid is expected to match the reference composition. Thus, by comparing the measured data set with the reference data set, it can be determined whether the fluid in the fluid container is contaminated.

Thus, the present invention provides a simple and efficient method of detecting contamination of a fluid in a fluid container.

As an initial matter, the detection of contamination of the fluid in a fluid container can be performed while the fluid is in the sample container. That is, it may not be required to remove the fluid or a sample of the fluid out of the fluid container and/or a device (e.g. mobile inhaler) comprising the fluid container. In other words, the method can particularly facilitate performing the detection of contamination locally wherein the fluid container is provided and furthermore without the need of handling or transporting the fluid out of the fluid container.

Secondly, because there may be no need to transport the fluid out of the fluid container, detection of contamination can be performed for each fluid container. Thus, instead of simply testing large batches of a fluid for contamination, as is typical in the prior art, the detection of contamination can be performed for each fluid container.

Thirdly, the measured data set can relate to an actual composition of the fluid in the fluid container at the instant when the measured data set is generated, e.g., when the measurement is performed. Thus, with the present method it can be possible to detect contamination of a fluid (or determine that the fluid in a fluid container is not contaminated) at different instances of time.

Furthermore, the present method can facilitate detecting contamination of a fluid in a fluid container automatically. As such, the detection of contamination can be performed fast and without the need of skilled persons.

For the above reasons, the present method can increase the frequency at which the fluid is analyzed for determining whether the fluid is contaminated, which can be particularly advantageous if the fluid is to be inhaled by a user, for example, if the fluid container is part of a mobile inhaler. As such, the present invention can facilitate reducing the risk of users inhaling contaminated fluids. That is, the present invention in a first aspect can provide a method for determining whether a fluid in a fluid container of a mobile inhaler is contaminated. This can avoid the use inhaling contaminated fluids which can be hazardous to the health of the user.

In the following, further features of the method according to a first aspect of the present will be discussed. It will be understood that the following features provide some exemplary embodiments of the method of the present invention.

In some embodiments, the method and more particularly the step of providing a reference data set can comprise storing the reference data set in a memory component and providing the reference data set from the memory component to the processing unit. That is, in general the method can comprise providing the reference data set to the processing unit. This is required such that the processing unit can compare it to the measured data set. In some embodiments, the reference data set can be provided to the processing unit by providing a memory component which can be accessed by the processing unit and storing the reference data set in the memory component. Thus, the processing unit may receive the reference data set from the memory component.

In embodiments, wherein the memory component is provided the method can comprise providing the reference data set to the memory component.

This can be performed during the manufacturing of the memory component. That is, the memory component can be manufactured to comprise the reference data set. A typical example of this, is the memory component comprising a read-only memory (ROM) manufactured to store or indicate the reference data set. This can be advantageous as it can ensure that the reference data set cannot be manipulated after manufacturing of the memory component.

Alternatively or additionally, the reference data set can be provided to the memory component after the manufacturing of the memory component, such as, during the assembly of a device or system comprising the memory component. In such embodiments, the memory component can comprise a programable memory wherein the reference data set can be provided and stored. Similarly, the reference data set can be provided to the memory component after the manufacturing of the memory component, such as, during the use of a device or system comprising the memory component.

In some embodiments, the method and particularly the step of providing the reference data set to the memory component can comprise storing in a database the reference data set, the processing unit sending to the database a request for the reference data set and providing the reference data set from the database to the memory component. As such, a database storing the reference data set can be provided. This can facilitate providing and storing reference data sets to the memory component automatically. For example, multiple devices comprising the memory component and the processing unit can be connected to the database and can automatically receive from therein the reference database. As such, an efficient distribution of the reference data set to multiple devices comprising the memory component and the processing unit can be performed. Furthermore, the database can facilitate the provision of the reference data set on demand, i.e., whenever requested by a processing unit.

In some embodiments, a plurality of reference data sets can be stored in the database. Each reference data set can relate to a respective reference composition. As it will be understood, different fluids may comprise different reference composition. Thus, the database may store the reference composition of different fluids. Furthermore, each reference composition may be labeled such that it can be determined to which fluid it can correspond to.

In such embodiments, the method can comprise the processing unit sending to the database a request for a reference data set related to a required reference composition and providing the reference data set related to the required reference composition from the database to the memory component. That is, the processing unit can send a request for a reference data set and extra data (e.g. label, identification data) that indicate the required reference data set from the plurality of reference data set. This can be particularly advantageous in embodiments wherein the fluid container can be part of a mobile inhaler, wherein different fluids (also referred as e-liquids) can be comprised in the fluid container of the mobile inhaler. Thus, depending on the fluid in the fluid container of a mobile inhaler, the processing unit can request from the database the corresponding reference data set. This can be particularly advantageous to cope with embodiments wherein the fluid in the fluid container is not fixed but can comprise different compositions, such as, an e-liquid of an e-cigarette.

The method may also comprise the processing unit searching the memory component for a reference data set related to the required reference composition before sending to the database a request for a reference data set related to the required reference composition, and the processing unit sending to the database a request for a reference data set related to the required reference composition if the reference data set related to the required reference composition is not stored in the memory component. This can avoid unnecessary communicating with the database for received a required reference composition. As it will be understood, receiving data from the database may be costly in terms of resources used, e.g., bandwidth and round-trip time to communicate with the database. On the other hand, communicating with the memory component which can be locally provided to the processing unit can be less costly. As such, the method can preserve resources by receiving reference data sets from the database only if they are not stored on the memory component.

As discussed, sending to the database a request for reference data set can comprise sending to the database a unique identification sequence assigned to the reference composition to which the requested reference data set relates to. More particularly, the reference data set(s) may comprise metadata or labels that facilitates differentiating the reference data sets from each other and identifying a particular reference data set.

In some embodiments, the method can comprise storing a plurality of reference data sets in the memory component each related to a respective reference composition. As discussed, providing a respective reference data sets for a plurality of fluids can be particularly advantageous for coping with embodiments wherein different fluid containers can comprise different fluids, which is typically the case for the e-liquids comprised in the fluid container of mobile inhalers. Firstly, providing a plurality of reference data sets to the memory component can allow different fluids to be analyzed for contamination. Secondly and particularly in embodiments wherein the database is provided as discussed above, providing a plurality of reference data sets to the memory component can reduce the amount of data needed to be transmitted between the database and the memory component, which can preserve bandwidth and time resources. In addition, providing a plurality of reference data sets to the memory component may also serve as a mechanism of controlling the types of fluids that can be comprised in the fluid container. For example, if a reference data set is not stored on the memory component (and/or on the database) the fluid can be determined as an alien fluid and/or as a contaminated fluid.

The reference data set can relate to or indicate a physical property depending on the composition of a fluid composed according to the reference composition, such as, a thermal property, an electrical property, an acoustical property, a magnetic property and an optical property. Alternatively or additionally, the reference data set can relate to or indicate a chemical property depending on the composition of a fluid composed according to the reference composition, such as, composition, acidity and alkalinity.

In some embodiments, the method can further comprise generating the reference data set. The reference data set can be generated by measuring at least one property that can indicate or relate to the composition of a fluid which is composed according to the reference composition. Moreover, the fluid which property is measured to generate the measured data set can priory be determined to be composed according to the reference composition. This can increase the likelihood of the reference data set accurately indicating or relating to the reference composition. The at least one property can be a physical property, a chemical property or any combination thereof.

In a similar manner, the measured data set can relate to at least one physical property depending on the actual composition of the fluid, such as, a thermal property, an electrical property, an acoustical property, a magnetic property and an optical property. Alternatively or additionally, the measure data set can relate to at least one chemical property depending on the actual composition of the fluid, such as, composition, acidity and alkalinity.

Generating the measured data set can comprise generating the measured data set such that it can relate to or indicate the same property of a fluid as the reference data set. This can facilitate comparing the reference data set and the measured data set to determine whether the fluid is contaminated.

In some embodiments, generating the measured data set can comprise utilizing a measuring device. More particularly, the measured data set can be generated by a measuring device measuring at least one of a physical and chemical property that depends on the actual composition of the fluid in the fluid container. This can further facilitate automating the method.

In general, comparing the reference data set with the measured data set can comprise calculating a distance metric between the measured data set and the reference data set that can indicate the similarity between the two data sets. Defining and calculating a distance metric for comparing the reference data set with the measured data set can provide a systematic way of comparing the reference data set with the measured data set. On the one hand this can facilitate performing the comparison automatically. On the other hand, the distance metric can provide a quantitative measure of the similarity or dissimilarity between the reference data set and the measured data set. In other words, calculating a distance metric can facilitate quantifying the level of contamination of the fluid, in addition to determining whether the fluid is contaminated.

Calculating the distance metric can comprise calculating a p-norm between the measured data set and the reference data set, wherein p is a real number larger or equal to 1, a Huber-norm between the measured data set and the reference data set, a correlation coefficient between the measured data set and the reference data set or any combination thereof.

It will be understood that the above are only some exemplary distance metrics that can be used to compare the measured data set with the reference data set.

In embodiments wherein comparing the reference data with the measured data set comprises calculating a distance metric between the two data sets, the method and particularly the step of providing a reference data set can comprise providing the reference data set with a distance metric threshold. That is, in addition to the reference data set a respective distance metric threshold can be provided. The distance metric threshold can facilitate determining whether the fluid is contaminated. More particularly, determining whether the fluid is contaminated based can comprise determining that the fluid is contaminated if the distance metric is larger than the distance metric threshold and determining that the fluid is not contaminated otherwise. Thus, by providing the distance metric threshold, the determination of whether the fluid is contaminated can be performed automatically, e.g., by the processing unit, by first calculating the distance metric and then comparing it with the distance metric threshold.

Alternatively or additionally, comparing the reference data set with the measured data set can comprise calculating a reference distribution of the reference data set, calculating a measured distribution of the measured data set and comparing the reference distribution with the measured distribution. That is, instead of directly comparing the reference data set with the measured data set (e.g. by calculating a distance metric), first the respective distributions or respective histograms of each data set can be calculated and then the distributions can be compared with each other.

The comparison between the reference distributions (i.e. the histogram or distribution of the reference data set) with the measured distribution (i.e. the histogram or distribution of the measured data set) can be based on a goodness of fit test, Kolmogorov-Smirnov test, Z-test or any combination thereof.

Alternatively or additionally to the above comparison methods, in some embodiments the comparison between the reference data and the measured data set can be performed in an element wise manner.

That is, the reference data set and the measured data set can each comprise a plurality of elements. Furthermore, each element on the measured data set can correspond to an element on the reference data set. For example, the reference data sent and the measured data set can comprise ordered elements, thus elements of the same or similar positions can correspond to each other. In another example, each element of the reference data set and the measured data set can comprise two attributed (e.g. an abscissa and an ordinate) and an element from the measured data set can correspond to an element from the reference data set if one of their attributes is the same or identical (e.g. the abscissa).

Thus, comparing the reference data set with the measured data set can comprise comparing each element from the measured data set with a respective element in the reference data set. Comparing each element from the measured data set with a respective element in the reference data set can comprise calculating for each pair of corresponding elements a respective indicator of the difference between the two elements. Furthermore, a tolerable threshold of said difference can be provided. In some embodiments, a respective tolerable threshold can be provided for each element of the reference data set. Based on the tolerable threshold, an element of the measured data set can be determined to be different from the respective element on the reference data set if the indicator of the difference between the two is larger in magnitude than the respective tolerable threshold. Thus, for each element on the measured data set it can be determined whether it is the same or different from the respective element in the reference data set.

Based on the element wise comparison, it can be determined whether the measured data set and the reference data set are the same or not. In some embodiments, it can be determined that the fluid is contaminated if at least a predetermined number or portion of elements of the measured data set are different from the respective elements on the reference data set.

Put simply, for each element on the measured data set it can be determined whether it is the same or different from the respective element in the reference data set. Further, the elements of the measured data set that are different from their respective elements on the reference data element set can be counted. Based on this count it can be determined whether the fluid is contaminated or not. For example, if the count is larger than a predetermined threshold then it can be determined that the fluid is contaminated.

In some embodiments, internal to the fluid container a heating element can be provided for heating the fluid in the fluid container by generating heat. The heating element can comprise at least one resistor, at least one inductor or any combination thereof. In general, the heating element can be any component configured to convert electrical energy into thermal energy. The presence of a heating element within a fluid container is particularly typical in mobile inhalers, such as, e-cigarettes. The mobile inhalers typically comprise a heating element that can contact the fluid. This is usually facilitated by a wick element (i.e. a fluid absorbent material) that can be submerged into the fluid (i.e. e-liquid) and also can contact the heating element. The wick element can absorb the fluid in the fluid container and draw into the heating element. Therein the fluid vaporizes and can be inhaled by the user of the mobile inhaler. As it will be discussed in the following embodiments, the heating element can be advantageous not only for facilitating the operation of a device comprising the fluid container (e.g. a mobile inhaler) but also for facilitating the detection of contamination of the fluid in the fluid container.

In some embodiments and particular in embodiments wherein the heating element can be provided, the step of providing a reference data set can comprise providing a reference electrical resistance data set related to the heating element.

The reference electrical resistance data set can comprise a plurality of reference electrical resistance values indicating the expected electrical resistance of the heating element if heating a fluid composed according to the reference composition.

Providing a reference electrical resistance data set related to the heating element can comprise measuring an electrical resistance of a heating element while heating a fluid composed according to the reference composition. Measuring the electrical resistance of the heating element can comprise measuring the electrical resistance of the heating element with an ohmmeter. For example, the reference electrical resistance data set can comprise a plurality of electrical resistance values measured at different times (e.g. periodically) while the heating element heats a fluid composed according to the reference composition. This can be referred to as a reference electrical resistance profile.

As it will be understood, the electrical resistance of the heating element can depend on the temperature of the heating element. As such, the reference electrical resistance data set can indicate the temperature of the heating element when heating a fluid composed according to the reference composition. Moreover, the temperature of the fluid and the temperature of the heating element during the heating depend on the properties of the fluid composed according to the reference composition, such as the thermal conductivity. Changing the composition of the fluid can change the properties (e.g. thermal conductivity) of the fluid and thus can change the temperature of the fluid and the temperature of the heating element during the heating. Corollary, changing the composition of the fluid can change the electrical resistance of the heating element during the heating. Put simply, the reference electrical resistance data set can be configured as a signature of the reference composition.

Measuring the electrical resistance of the heating element can comprise providing a power current and a measuring signal to the heating element in an alternating pattern such that only one of the power current and the measuring signal passes through the heating element at a time. The power current can be provided to the heating element for generating heat and the measuring signal can be provided to the heating element for measuring the electrical resistance of the heating element. This can facilitate measuring the electrical resistance of the heating element more precisely by calibrating the measuring signal.

The power current can have a power of at least 2 wats and at most 250 watts. This can be advantageous for supplying sufficient energy for heating the fluid in the fluid container.

The measuring signal can have a power of at most 1 watt. This can be advantageous for generating a calibrated signal and thus performing a precise measurement of the electrical resistance.

In some embodiments and particularly in embodiments wherein the reference data set can comprise a reference electrical resistance data set, generating a measured data set can comprise generating a measured electrical resistance data set related to the heating element.

The measured electrical resistance data set can comprise a plurality of electrical resistance values indicating the electrical resistance of the heating element while heating the fluid in the fluid container.

Generating a measured electrical resistance data set related to the heating element can comprise the measuring device measuring the electrical resistance of the heating element while heating the fluid in the fluid container. In such embodiments, the measuring device can comprise an ohmmeter. For example, the measured electrical resistance data set can comprise a plurality of electrical resistance values measured at different times (e.g. periodically) while the heating element heats the fluid in the fluid container. This can be referred to as a measured electrical resistance profile.

Measuring the electrical resistance of the heating element can comprise providing a power current and a measuring signal to the heating element in an alternating pattern such that only one of the power current and the measuring signal passes through the heating element at a time. The power current can be provided to the heating element for generating heat and the measuring signal can be provided to the heating element for measuring the electrical resistance of the heating element.

The power current can have a power of at least 2 wats and at most 250 watts.

The measuring signal can have a power of at most 1 watt.

As discussed above, the composition of the fluid in the fluid container can affect the electrical resistance of the heating element. As such, each composition of the fluid can cause a corresponding electrical resistance behavior of the heating element. More particularly, the reference electrical resistance data set can characterize or can indicate the reference composition of a fluid. Similarly, the measured electrical resistance data set can characterize or can indicate the actual composition of the fluid in the fluid container. Thus, comparing the reference electrical resistance data set and the measured electrical resistance data set, it can be determined whether the actual composition of the fluid in the fluid container resembles or is the same with the reference composition. Based on this, it can be determined whether the fluid in the fluid container is contaminated.

In some embodiments, the method can comprise providing a reference temperature data set related to the heating element.

The reference temperature data set can comprise a plurality of reference temperature values indicating the expected temperature of the heating element if heating a fluid composed according to the reference composition.

Providing a reference temperature data set related to the heating element can comprise measuring the temperature of a heating element while heating a fluid composed according to the reference composition.

Alternatively or additionally, providing a reference temperature data set related to the heating element can comprise measuring an electrical resistance of a heating element while heating a fluid composed according to the reference composition and calculating a temperature of the heating element based on the measured resistance of the heating element. The electrical resistance of the heating element while heating a fluid composed according to the reference composition can be measured as discussed above.

As discussed above, the temperature of the heating element while heating a fluid composed according to the reference compositions can depend on the properties of the fluid composed according to the reference composition. As such, the reference temperature data set can be configured as a signature of the reference composition, i.e. can characterize or can indicate a fluid composed according to the reference composition.

In some embodiments and particularly in embodiments wherein the reference data set can comprise a reference temperature data set, generating a measured data set can comprise generating a measured temperature data set related to the heating element. The measured temperature data set can comprise a plurality of temperature values indicating the temperature of the heating element while heating the fluid in the fluid container.

Generating a measured temperature data set related to the heating element can comprise measuring the temperature of the heating element while heating the fluid in the fluid container.

Alternatively or additionally, generating a measured temperature data set related to the heating element can comprise the measuring device measuring the electrical resistance of the heating element while heating the fluid in the fluid container and calculating a temperature of the heating element based on the measured resistance of the heating element. The measuring device can measure the electrical resistance of the heating element while heating the fluid in the fluid container as discussed above.

The measuring device can comprise at least one of a thermistor, thermocouple, resistance thermometer and silicon bandgap temperature sensor.

The heating element and the measuring device can be parts of a thermistor or a resistance thermometer.

In some embodiments, providing a reference data set can comprise providing a reference thermal capacity data set related to a fluid composed according to the reference composition.

The reference thermal capacity data set can comprise a plurality of reference thermal capacity values each indicating an expected thermal capacity of the fluid in the fluid container if composed according to the reference composition.

Each thermal capacity value in the reference thermal capacity data set can indicate an expected thermal capacity of the fluid in the fluid container if composed according to the reference composition while the fluid is at certain temperature.

Providing a reference thermal capacity data set can comprise measuring at least one temperature of a heating element while heating a fluid composed according to the reference composition and calculating based on the at least one measured temperature of the heating element at least one thermal capacity of the fluid composed according to the reference composition and generating the reference thermal capacity data set based on the at least one calculated thermal capacity of the fluid composed according to the reference composition.

Alternatively or additionally, providing a reference thermal capacity data set can comprise measuring at least one temperature of a fluid composed according to the reference composition while heating the fluid composed according to the reference composition and calculating based on the at least one measured temperature of the fluid composed according to the reference composition at least one thermal capacity of the fluid composed according to the reference composition and generating the reference thermal capacity data set based on the at least one calculated thermal capacity of the fluid composed according to the reference composition.

Based on the composition, a material (e.g. the fluid) can comprise a particular thermal capacity. The thermal capacity of a fluid can be measured by measuring the temperature of the fluid in the fluid container and/or the temperature of the heating element. The temperature measurements can be performed as discussed above.

Similarly, generating a measured data set can comprise generating a measured thermal capacity data set related to the fluid in the fluid container.

The measured thermal capacity data set can comprise a plurality of thermal capacity values indicating the thermal capacity of the fluid in the fluid container.

Each thermal capacity value can indicate the thermal capacity of the fluid in the fluid container while the fluid is at a certain temperature.

Generating a measured thermal capacity data set can comprise measuring at least one temperature of the heating element while heating the fluid in the fluid container and calculating based on the at least one measured temperature of the heating element at least one thermal capacity of the fluid in the fluid container and generating the measured thermal capacity data set.

Alternatively or additionally, generating a measured thermal capacity data set can comprise measuring at least one temperature of the fluid in the fluid container while heating the fluid in the fluid container, and calculating based on the at least one measured temperature of the fluid in the fluid container at least one thermal capacity of the fluid in the fluid container, and generating the measured thermal capacity data set based on the at least one calculated thermal capacity of the fluid in the fluid container.

In the above, different embodiments of the method for determining contamination were discussed. More particularly, detecting contamination by measuring the electrical resistance of the heating element, the temperature of the heating element and/or the thermal capacity of the fluid in the fluid container were discussed. These embodiments are based on the rationale that the composition of the fluid affects the way that the fluid conducts heat. Thus, the composition of the fluid can affect the electrical resistance of the heating element, the temperature of the heating element and the thermal capacity of the fluid, while heating the fluid. This can allow determining whether a fluid in the fluid container is contaminated by comparing the electrical resistance of the heating element, the temperature of the heating element and the thermal capacity of the fluid while heating the fluid in the fluid container with electrical resistance of the heating element, the temperature of the heating element and the thermal capacity of the fluid, while heating a fluid composed according to the reference composition, respectively.

Such embodiments are particularly advantageous as they require minimum hardware components for detecting contamination. More particularly, a heating element and a measuring device (e.g. ohmmeter) can be utilized for detecting contamination. Moreover, in multiple applications (e.g. mobile inhalers) the fluid container typically already comprises a heating element. As such, configuring the fluid containers and/or devices comprising the fluid container (e.g. mobile inhalers) to detect contamination may require minimal configurations and extra hardware components and can have a minimal impact on the size of the fluid containers and/or devices.

In some embodiments, the method can comprise providing a first component and a second component at a distance from each other and internally to the fluid container.

The first component and the second component can be connected with the measuring device. As such, the first and the second component may facilitate the measuring device measuring at least one property of the fluid.

In some embodiments, the first component and the second component can respectively comprise at least one electrode.

In such embodiments, providing a reference data set can comprise providing a reference fluid electrical resistance data set related to a fluid composed according to the reference composition.

The reference fluid electrical resistance data set can comprise a plurality of reference fluid electrical resistance values indicating the expected electrical resistance of the fluid in the fluid container if composed according to the reference composition.

Providing a reference fluid electrical resistance data set can comprise measuring the electrical resistance of a fluid composed according to the reference composition.

Measuring the electrical resistance of the fluid composed according to the reference composition measuring the electrical resistance of the fluid composed according to the reference composition with an ohmmeter connected to a reference first component and to a reference second component, both immersed in the fluid composed according to the reference composition. That is, an electrical signal can be transmitted between the electrodes (i.e. first and second component). As the electrodes are immersed in the fluid composed according to the reference composition, the electrical signal is conducted from one electrode to the other by the fluid. This, allows the measuring of the electrical resistance of the fluid.

Typically, different compositions of a fluid can comprise different resistance values (i.e. different resistivities). As such, the reference fluid electrical resistance data set can indicate or characterize a fluid composed according to the reference composition.

Similarly, generating a measured data set can comprise generating a measured fluid electrical resistance data set related to the fluid in the fluid container.

The measured fluid electrical resistance data set can comprise a plurality of fluid electrical resistance values corresponding to the electrical resistance of the fluid in the fluid container.

Generating a measured fluid electrical resistance data set related to the heating element can comprise the measuring device measuring the electrical resistance of the fluid in the fluid container. The measuring device can comprise an ohmmeter connected to the first component and second component.

As discussed, the electrical resistance of a fluid can depend on the composition of the fluid. As such, each composition of the fluid can comprise a corresponding electrical resistance behavior. More particularly, the reference fluid electrical resistance data set can characterize or can indicate the reference composition of a fluid. Similarly, the measured fluid electrical resistance data set can characterize or can indicate the actual composition of the fluid in the fluid container. Thus, comparing the reference fluid electrical resistance data set and the measured fluid electrical resistance data set, it can be determined whether the actual composition of the fluid in the fluid container resembles or is the same with the reference composition. Based on this, it can be determined whether the fluid in the fluid container is contaminated.

In some embodiments, the first component can emit a measuring signal, preferably an electromagnetic wave with a narrow beam-width, such as, a laser beam and the second component can receive the measuring signal after the measuring signal propagates through the fluid in the fluid container and at least one other medium. In such embodiments, the first component can comprise a transmitter and the second component can comprise a receiver. Alternatively, the first component and the second component can respectively comprise a transceiver.

In such embodiments, providing the reference data set can comprise providing a reference refractive index data set related to a fluid composed according to the reference composition.

The measured refractive index data set can comprise at least one refractive index value each indicating an expected refractive index of the fluid in the fluid container if composed according to the reference composition.

Providing a measured refractive index data set can comprise measuring a refractive index of a fluid composed according to the reference composition.

Similarly, generating the measured data set can comprise generating a measured refractive index data set related to the fluid in the fluid container.

The measured refractive index data set can comprise at least one refractive index value indicating the refractive index of the fluid in the fluid container.

Generating a measured refractive index data set can comprise the measuring device measuring a refractive index of the fluid in the fluid container.

The measuring device measuring a refractive index of the fluid in the fluid container can comprise configuring the second component to indicate a position of incidence of the measuring signal and determining the refractive index of the fluid in the fluid container based on the position of incidence of the measuring signal.

The second component can comprise a plurality of detection elements each configured to change a respective detection element property when the measuring signal is incident on the detection element.

The reference composition of the fluid can refer to the intended, expected and/or required composition of the fluid.

The reference composition can relate to a list of chemical elements and/or chemical compounds that are intended, expected and/or required to be in the fluid.

The reference data set can further comprise for each chemical elements and/or chemical compounds in the list of chemical elements and/or chemical compounds intended, expected and/or required to be in the fluid, a respective portion that the chemical elements and/or chemical compounds is intended, expected and/or required to be in the fluid.

As discussed above and/or similar to the above discussion, different properties can be measured for detecting contamination. That is, the measured data set can indicate a thermal capacity of the fluid in the fluid container, an electrical conductivity of the fluid in the fluid container, an electrical resistance of the fluid in the fluid container, a magnetic permeability of the fluid in the fluid container, a refractive index of the fluid in the fluid container, an acidity measure of the fluid in the fluid container, an alkalinity measure of the fluid in the fluid container, a spectroscopic measurement of the fluid, or any combination thereof.

Similarly, the reference data set can indicate an expected thermal capacity of the fluid in the fluid container if composed according to the reference composition, an expected electrical conductivity of the fluid in the fluid container if composed according to the reference composition, an expected electrical resistance of the fluid in the fluid container if composed according to the reference composition, an expected magnetic permeability of the fluid in the fluid container if composed according to the reference composition, an expected refractive index of the fluid in the fluid container if composed according to the reference composition, an expected acidity measure of the fluid in the fluid container if composed according to the reference composition, an expected alkalinity measure of the fluid in the fluid container if composed according to the reference composition, an expected spectroscopic measure of the fluid if composed according to the reference composition, or any combination thereof.

The fluid can be a liquid, liquid solution, gas, aerosol, vapor used in a mobile inhaler, such as, in an e-cigarette.

The fluid container can be part of a mobile inhaler, such as, an e-cigarette.

The fluid container can be attached to a mobile inhaler, such as, an e-cigarette.

The method can be used to detect contamination of a fluid used by a mobile inhaler, such as, an e-cigarette.

In a further aspect the present invention can relate to a method for detecting contamination of a fluid in at least one fluid container of a mobile inhaler according to any of the method embodiments discussed above.

In some embodiments, the method can be a computer implemented method configured to facilitate the detection of contamination in a fluid container.

In some embodiments, the method can be a computer program product configured to facilitate the detection of contamination in a fluid container.

In a further aspect, the present invention relates to the use of the method according to any of the preceding method embodiments, to detect contamination of a fluid in a fluid container.

In a further aspect, the present invention relates to the use of the method according to any of the preceding method embodiments, to detect contamination of a fluid in at least one fluid container of a mobile inhaler.

In a further aspect the present invention relates to a system configured to detect contamination of a fluid in a fluid container. The system comprises a fluid container configured to be at least partly filled with a fluid, a memory component configured to store a reference data set related to a reference composition of the fluid, a measuring device configured to generate a measured data set related to the composition of the fluid and a processing unit configured to compare the measured data set with the reference data set and determine based on the comparison whether the fluid is contaminated.

Thus, the present invention provides a simple and efficient system of detecting contamination of a fluid in a fluid container. The system comprises corresponding features and advantages discussed with reference to the method embodiments of the first aspect of the present invention, omitted herein for the sake of brevity.

The fluid container can comprise at least one reservoir, each configured to contain a fluid.

The measuring device can be configured to measure at least one property depending on the composition of the fluid in the fluid container. The at least one property can be a physical property depending on the composition of the fluid in the fluid container, such as, a thermal property, an electrical property, an acoustical property, a magnetic property and an optical property or any combination thereof. Alternatively or additionally, the at least one property can be a chemical property depending on the composition of a fluid the fluid in the fluid container, such as, composition, acidity and alkalinity, or any combination thereof.

The fluid in the fluid container can be a fluid to be tested for contamination, i.e., a fluid under test.

In some embodiments, the fluid in the fluid container can be a non-contaminated fluid composed according to the reference composition and the system can be used to generate the reference data set. That is, the fluid container can be filled with a fluid, which is known to be composed according to the reference composition. This facilitates the generation of the reference data set, by measuring with the reference device the non-contaminated fluid. In other words, by providing the fluid container filled with a non-contaminated fluid the measured data set generated by the measuring device corresponds to a reference data set. Thus, for example, the system may comprise an initialization phase, wherein the fluid in the fluid container is not contaminated (i.e. is composed according to the reference composition) and the system can be configured generate the reference data set. The reference data set can be stored in the memory component. Afterwards, the system can test the fluid in the fluid container for contamination. This can allow testing whether the fluid, initially provided non-contaminated, is contaminated at a later time. Alternatively, this can allow testing for contamination other fluids that can be introduced into the fluid container and/or the fluid of other fluid containers that can be provided to the system.

The processing unit can comprise one or more processors or processing cores, such as, at least one CPU (central processing unit), at least one GPU (graphical processing unit), at least one DSP (digital signal processor), at least one APU (accelerator processing unit), at least one ASIC (application-specific integrated circuit), at least one ASIP (application-specific instruction-set processor), at least one FPGA (field programable gate array) or any combination thereof.

The memory component can comprise a volatile and/or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), Parameter RAM (P-RAM), solid-state drive or any combination thereof.

The processing unit can be configured to send and receive data to/from the memory component. This can allow the memory component to provide the reference data set to the memory component for being stored therein and/or to receive the reference data set already stored in the memory component.

The processing unit and the measuring device can be configured for data communication with each other. This can facilitate the processing unit providing control data to the measuring device. Alternatively or additionally, this can facilitate the measuring device providing the measured data set and/or raw measured data to the processing unit.

The system may further comprise an indication unit that can be configured to output an indication of the determination whether the fluid in the fluid container is contaminated. The indication can be a visual, audio and/or haptic indication.

The system can further comprise a heating element internal to the fluid container configured to heat the fluid in the fluid container by generating heat. As discussed, the heating element can be advantageous not only for facilitating the operation of a device comprising the fluid container (e.g. a mobile inhaler) but also for facilitating the detection of contamination of the fluid in the fluid container.

The heating element can comprise at least one resistor, at least one inductor or any combination thereof.

The system can comprise at least one signal guider configured to electrically connect the measuring device with the heating element. The signal guider can comprise one or more electrical wire(s). This can facilitate the measuring device providing a measuring signal to the heating element.

The measuring device can comprise at least one of ohmmeter, a thermistor, thermocouple, resistance thermometer and silicon bandgap temperature sensor, thermometer.

The measuring device can be configured to measure a temperature of the fluid in the fluid container.

The measuring device can be configured to measure a thermal capacity of the fluid in the fluid container.

The measuring device can be configured to measure an electrical resistance of the heating element.

The system can further comprise a first component and a second component at a distance from each other and internally to the fluid container. In such embodiments, the system can comprise at least one signal guider configured to electrically connect the measuring device with the first component and at least one signal guider configured to electrically connect the measuring device with the second component. This can facilitate the measuring device providing/receiving a measuring signal to/from the first and second components.

The first component and the second component can comprise at least one electrode, respectively.

The measuring device can be configured to measure an electrical resistance of the fluid in the fluid container.

The first component can be configured to emit a measuring signal, preferably an electromagnetic wave with a narrow beam-width, such as, a laser beam and the second component can be configured to receive the measuring signal after the measuring signal propagates through the fluid in the fluid container and at least one other medium.

The first component can comprise at least one of an electromagnetic wave transmitting antenna, light source, laser, LED or any combination thereof, and the second component can comprise at least one of an electromagnetic wave receiver, electromagnetic wave detector, light sensor, optical sensor, image sensor or any combination thereof.

The system can further comprise a collimator lens configured to focus the electromagnetic wave emitted by the first component.

The electromagnetic wave emitted by the first component can comprise a wavelength between 300 nanometers to 1 millimeter, preferably between, 300 nanometers to 700 nanometers.

The measuring device can be configured to measure a refractive index of the fluid in the fluid container.

The system can further comprise a mobile inhaler, such as, an e-cigarette and wherein the fluid container is attached to the mobile inhaler, in a releasable or non-releasable manner.

The mobile inhaler can comprise a mouthpiece that can be configured to be taken into the mouth of a user of the mobile inhaler.

The mobile inhaler can comprise at least one canal configured to guide a fluid, such as, a vapor, from the fluid container to the mouthpiece.

The mobile inhaler can comprise an energy storage component.

The system can further comprise a database configured to store at least one reference data set.

The processing unit and the database can be configured for data communication.

The processing unit can be configured to send at least one database query to the database and the database can be configured to send data to the processing unit.

The system can be configured to carry out the method according to any of the preceding method embodiments. That is, the system and the method can comprise corresponding features.

In a further aspect, the present invention relates to a system for detecting contamination of a fluid in at least one fluid container of a mobile inhaler according to any of the preceding system embodiments.

In a further aspect, the present invention relates to a use of the system according to any of the preceding method embodiments, to detect contamination of a fluid in a fluid container.

In a further aspect, the present invention relates to a use of the system according to any of the preceding method embodiments, to detect contamination of a fluid in at least one fluid container of a mobile inhaler.

In a further aspect, the present invention relates to a mobile inhaler comprising at least one fluid container configured to be at least partly filled with a fluid, a memory component configured to store a reference data set related to a reference composition of the fluid, a measuring device configured to generate a measured data set related to the composition of the fluid and a processing unit configured to compare the measured data set with the reference data set and determine based on the comparison whether the fluid is contaminated.

The mobile inhaler discussed herein, comprises corresponding features and advantages discussed with reference to the above system and/or method embodiments and are omitted herein for the sake of brevity.

Each of the fluid containers can comprise at least one reservoir, each configured to contain a fluid, such as, an e-liquid.

The measuring device can be configured to measure at least one property depending on the composition of the fluid in the fluid container. The at least one property can be a physical property depending on the composition of the fluid in the fluid container, such as, a thermal property, an electrical property, an acoustical property, a magnetic property and an optical property or any combination thereof. Alternatively or additionally, the at least one property can be a chemical property depending on the composition of a fluid the fluid in the fluid container, such as, composition, acidity and alkalinity, or any combination thereof.

The fluid in the fluid container can be a fluid to be tested for contamination, i.e., a fluid under test.

In some embodiments, the fluid in the fluid container can be a non-contaminated fluid composed according to the reference composition and the mobile inhaler can be used to generate the reference data set. That is, the fluid container can be filled with a fluid, which is known to be composed according to the reference composition. This facilitates the generation of the reference data set, by measuring with the reference device the non-contaminated fluid.

In other words, by providing the fluid container filled with a non-contaminated fluid the measured data set generated by the measuring device corresponds to a reference data set. Thus, for example, the mobile inhaler may comprise an initialization phase, wherein the fluid in the fluid container is not contaminated (i.e. is composed according to the reference composition) and the mobile inhaler can be configured generate the reference data set. The reference data set can be stored in the memory component. Afterwards, the mobile inhaler can test the fluid in the fluid container for contamination. This can allow testing whether the fluid, initially provided non-contaminated, is contaminated at a later time. Alternatively, this can allow testing for contamination other fluids that can be introduced into the fluid container and/or the fluid of other fluid containers that can be provided to the mobile inhaler.

The processing unit can comprise one or more processors or processing cores, such as, at least one CPU (central processing unit), at least one GPU (graphical processing unit), at least one DSP (digital signal processor), at least one APU (accelerator processing unit), at least one ASIC (application-specific integrated circuit), at least one ASIP (application-specific instruction-set processor), at least one FPGA (field programable gate array) or any combination thereof.

The memory component can comprise a volatile and/or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), Parameter RAM (P-RAM), solid-state drive or any combination thereof.

The processing unit can be configured to send and receive data to/from the memory component. This can allow the memory component to provide the reference data set to the memory component for being stored therein and/or to receive the reference data set already stored in the memory component.

The processing unit and the measuring device can be configured for data communication with each other. This can facilitate the processing unit providing control data to the measuring device. Alternatively or additionally, this can facilitate the measuring device providing the measured data set and/or raw measured data to the processing unit.

The system may further comprise an indication unit that can be configured to output an indication of the determination whether the fluid in the fluid container is contaminated. The indication can be a visual, audio and/or haptic indication.

The mobile inhaler can further comprise a heating element internal to the fluid container configured to heat the fluid in the fluid container by generating heat. As discussed, the heating element can be advantageous not only for facilitating the operation of a device comprising the fluid container (e.g. a mobile inhaler) but also for facilitating the detection of contamination of the fluid in the fluid container.

The heating element can comprise at least one resistor, at least one inductor or any combination thereof.

The mobile inhaler can comprise at least one signal guider configured to electrically connect the measuring device with the heating element. The signal guider can comprise one or more electrical wire(s). This can facilitate the measuring device providing a measuring signal to the heating element.

The measuring device can comprise at least one of ohmmeter, a thermistor, thermocouple, resistance thermometer and silicon bandgap temperature sensor, thermometer.

The measuring device can be configured to measure a temperature of the fluid in the fluid container.

The measuring device can be configured to measure a thermal capacity of the fluid in the fluid container.

The measuring device can be configured to measure an electrical resistance of the heating element.

The mobile inhaler can further comprise a first component and a second component at a distance from each other and internally to the fluid container. In such embodiments, the mobile inhaler can comprise at least one signal guider configured to electrically connect the measuring device with the first component and at least one signal guider configured to electrically connect the measuring device with the second component. This can facilitate the measuring device providing/receiving a measuring signal to/from the first and second components.

The first component and the second component can comprise at least one electrode, respectively.

The measuring device can be configured to measure an electrical resistance of the fluid in the fluid container.

The first component can be configured to emit a measuring signal, preferably an electromagnetic wave with a narrow beam-width, such as, a laser beam and the second component can be configured to receive the measuring signal after the measuring signal propagates through the fluid in the fluid container and at least one other medium.

The first component can comprise at least one of an electromagnetic wave transmitting antenna, light source, laser, LED or any combination thereof, and the second component can comprise at least one of an electromagnetic wave receiver, electromagnetic wave detector, light sensor, optical sensor, image sensor or any combination thereof.

The mobile inhaler can further comprise a collimator lens configured to focus the electromagnetic wave emitted by the first component.

The electromagnetic wave emitted by the first component can comprise a wavelength between 300 nanometers to 1 millimeter, preferably between, 300 nanometers to 700 nanometers.

The measuring device can be configured to measure a refractive index of the fluid in the fluid container.

The mobile inhaler can further comprise a mobile inhaler, such as, an e-cigarette and wherein the fluid container is attached to the mobile inhaler, in a releasable or non-releasable manner.

The mobile inhaler can comprise a mouthpiece that can be configured to be taken into the mouth of a user of the mobile inhaler.

The mobile inhaler can comprise at least one canal configured to guide a fluid, such as, a vapor, from the fluid container to the mouthpiece.

The mobile inhaler can comprise an energy storage component.

The mobile inhaler can further be configured to transfer data with a database configured to store at least one reference data set.

The processing unit and the database can be configured for data communication.

The processing unit can be configured to send at least one database query to the database and the database is configured to send data to the processing unit.

The mobile inhaler can be configured to allow a fluid in a fluid container to be delivered to a user, if the processing unit determines that the fluid is not contaminated.

The mobile inhaler can be configured to carry out the method according to any of the preceding method embodiments.

The mobile inhaler can be configured to detect contamination of the fluid in the at least one fluid container.

The present technology is also defined by the following numbered embodiments.

Below, method embodiments will be discussed. These embodiments are identified by the letter M followed by a number. When reference is herein made to method embodiments, these embodiments are meant.
M1. A method for detecting contamination of a fluid in a fluid container (10), the method comprising:

providing a reference data set (35) related to a reference composition of the fluid;

generating a measured data set (55) related to an actual composition of the fluid in the fluid container (10);

a processing unit (40) comparing the reference data set (35) with the measured data set (55);

determining whether the fluid is contaminated based on the comparison.

### Providing Reference Data Set

M2. The method according to the preceding embodiment, wherein providing a reference data set (35) comprises

storing the reference data set (35) in a memory component (30), and

providing the reference data set (35) from the memory component (30) to the processing unit (40).
M3. The method according to the preceding embodiment, wherein the method comprises providing the reference data set (35) to the memory component (30).
M4. The method according to the preceding embodiment, wherein providing the reference data set (35) to the memory component (30) comprises

providing the reference data set (35) to the memory component (30) during the manufacturing of the memory component (30),

providing the reference data set (35) to the memory component (30) during assembly of a device or system comprising the memory component (30),

providing the reference data set (35) to the memory component (30) during use of a device or system comprising the memory component (30), or any combination thereof.
M5. The method according to any of the 2 preceding embodiments, wherein providing the reference data set (35) to the memory component (30) comprises

storing in a database the reference data set (35),

the processing unit (30) sending to the database a request for the reference data set (35),

providing the reference data set (35) from the database to the memory component (30).
M6. The method according to any of the 3 preceding embodiments, wherein providing the reference data set (35) to the memory component (30) comprises

storing in a database a plurality of reference data sets (35) each related to a respective reference composition,

the processing unit (30) sending to the database a request for a reference data set (35) related to a required reference composition,

providing the reference data set (35) related to the required reference composition from the database to the memory component (30).
M7. The method according to the preceding embodiment and further comprising

the processing unit (40) searching the memory component (30) for a reference data set (35) related to the required reference composition before sending to the database a request for a reference data set (35) related to the required reference composition, and

the processing unit (40) sending to the database a request for a reference data set (35) related to the required reference composition if the reference data set (35) related to the required reference composition is not stored in the memory component (30).
M8. The method according to any of the 3 preceding embodiments, wherein sending to the database a request for reference data set (35) comprises sending to the database a unique identification sequence assigned to the reference composition to which the requested reference data set (35) relates to.
M9. The method according to any of the 7 preceding embodiments, wherein storing the reference data set (35) in a memory component (30) comprises

storing a plurality of reference data sets (35) in the memory component (35) each related to a respective reference composition.
M10. The method according to the preceding embodiment, wherein storing a plurality of reference data sets (35) in the memory component (35) each related to a respective reference composition comprises

storing each reference data sets (35) with a respective unique identification sequence assigned to it.

### Generating Reference Data Set

M11. The method according to any of the preceding embodiments, wherein the reference data set (35) relates to at least one of

a physical property depending on the composition of a fluid composed according to the reference composition, such as, a thermal property, an electrical property, an acoustical property, a magnetic property and an optical property,

a chemical property depending on the composition of a fluid composed according to the reference composition, such as, composition, acidity and alkalinity,

or any combination thereof.
M12. The method according to any of the preceding embodiments, wherein the method comprises generating the reference data set (35) by measuring at least one of

a physical property depending on the composition of a fluid composed according to the reference composition, such as, a thermal property, an electrical property, an acoustical property, a magnetic property and an optical property,

a chemical property depending on the composition of a fluid composed according to the reference composition, such as, composition, acidity and alkalinity,

or any combination thereof.

### Generating Measured Data Set

M13. The method according to any of the preceding embodiments, wherein the measured data set (55) relates to at least one of

a physical property depending on the actual composition of the fluid, such as, a thermal property, an electrical property, an acoustical property, a magnetic property and an optical property,

a chemical property depending on the actual composition of the fluid, such as, composition, acidity and alkalinity,

or any combination thereof.
M14. The method according to the preceding embodiment, wherein the measured data set (55) and the reference data set (35) relate to the same property.
M15. The method according to any of the preceding embodiments, wherein generating a measured data set (55) comprises a measuring device (50) measuring at least one of

a physical property depending on the actual composition of the fluid, such as, a thermal property, an electrical property, an acoustical property, a magnetic property and an optical property,

a chemical property depending on the actual composition of the fluid, such as, composition, acidity and alkalinity,

or any combination thereof

### Comparing

M16. The method according to any of the preceding embodiments, wherein a processing unit (40) comparing the reference data set (35) with the measured data set (55) comprises

the processing unit (40) calculating a distance metric between the measured data set (55) and the reference data set (35) that indicates the similarity between the reference data set (35) and the measured data set (55).
M17. The method according to the preceding embodiment, wherein calculating a distance metric between the measured data set (55) and the reference data set (35) comprises calculating at least one of

a p-norm between the measured data set (55) and the reference data set (35), wherein p is a real number larger or equal to 1,

a Huber-norm between the measured data set (55) and the reference data set (35),

a correlation coefficient between the measured data set (55) and the reference data set (35),

or any combination thereof.
M18. The method according to any of the 2 preceding embodiments, wherein

providing a reference data set (35) comprises providing the reference data set (35) with a distance metric threshold and

determining whether the fluid is contaminated based on the comparison comprises determining that the fluid is contaminated if the distance metric is larger than the distance metric threshold and determining that the fluid is not contaminated otherwise.
M19. The method according to any of the preceding embodiments, wherein a processing unit (40) comparing the reference data set (35) with the measured data set (55) comprises

calculating a reference distribution of the reference data set (35),

calculating a measured distribution of the measured data set (55), and

comparing the reference distribution with the measured distribution.
M20. The method according to the preceding embodiment, wherein comparing the reference distribution with the measured distribution is performed based on at least one of a goodness of fit test, a Kolmogorov-Smirnov test, a Z-test or any combination thereof.
M21. The method according to any of the preceding embodiments,

wherein providing the reference data set (35) comprises

providing for each element in the reference data set (35) a respective tolerable threshold and

wherein a processing unit (40) comparing the reference data set (35) with the measured data set (55) comprises

comparing an indication of the difference between an element of the measured data set (55) and the respective element in the reference data set (35) with a respective tolerable threshold.
M22. The method according to the preceding embodiment, wherein

determining whether the fluid is contaminated based on the comparison comprises determining that the fluid is contaminated if the difference between an element of the reference data set (35) and the respective element in the measured data set (55) is larger than the tolerable threshold for at least a predetermined number of elements in the measured data set (55) and determining that the fluid is not contaminated otherwise.

### Heating Element

M23. The method according to any of the preceding embodiments, wherein a heating element (130) is provided internal to the fluid container (10) heating the fluid in the fluid container (10) by generating heat.
M24. The method according to the preceding embodiment, wherein the heating element (130) comprises at least one resistor, at least one inductor or any combination thereof.

### Reference Electrical Resistance Data Set

M25. The method according to any of the preceding embodiments and with the features of embodiment M23, wherein providing a reference data set (35) comprises

providing a reference electrical resistance data set (35) related to the heating element (130).
M26. The method according to the preceding embodiment, wherein the reference electrical resistance data set (35) comprises a plurality of reference electrical resistance values indicating the expected electrical resistance of the heating element (130) if heating a fluid composed according to the reference composition.
M27. The method according to any of the two preceding embodiments, wherein providing a reference electrical resistance data set (35) related to the heating element (130) comprises measuring an electrical resistance of a heating element (130) while heating a fluid composed according to the reference composition.
M28. The method according to the preceding embodiment, wherein measuring the electrical resistance of the heating element (130) comprises

measuring the electrical resistance of the heating element (130) with an ohmmeter.
M29. The method according to any of the two preceding embodiments, wherein measuring the electrical resistance of the heating element (130) comprises

providing a power current and a measuring signal to the heating element (130) in an alternating pattern such that only one of the power current and the measuring signal passes through the heating element (130) at a time,

wherein the power current is provided to the heating element (130) for generating heat and the measuring signal is provided to the heating element (130) for measuring the electrical resistance of the heating element.
M30. The method according to the preceding embodiment, wherein the power current has a power of at least 2 wats and at most 250 watts.
M31. The method according to any of the two preceding embodiments, wherein the measuring signal has a power of at most 1 watt.

### Measured Electrical Resistance Data Set

M32. The method according to any of the preceding embodiments and with the features of embodiment M23, wherein generating a measured data set (55) comprises generating a measured electrical resistance data set (55) related to the heating element (130).
M33. The method according to the preceding embodiment, wherein the measured electrical resistance data set (55) comprises a plurality of electrical resistance values indicating the electrical resistance of the heating element (130) while heating the fluid in the fluid container (10).
M34. The method according to any of the two preceding embodiments and with the features of embodiment M15, wherein generating a measured electrical resistance data set (55) related to the heating element (130) comprises

the measuring device (50) measuring the electrical resistance of the heating element (130) while heating the fluid in the fluid container (10).
M35. The method according to the preceding embodiment, wherein the measuring device (50) comprises an ohmmeter.
M36. The method according to any of the two preceding embodiments, wherein measuring the electrical resistance of the heating element (130) comprises

providing a power current and a measuring signal to the heating element (130) in an alternating pattern such that only one of the power current and the measuring signal passes through the heating element (130) at a time,

wherein the power current is provided to the heating element (130) for generating heat and the measuring signal is provided to the heating element (130) for measuring the electrical resistance of the heating element (130).
M37. The method according to the preceding embodiment, wherein the power current has a power of at least 2 wats and at most 250 watts.
M38. The method according to any of the two preceding embodiments, wherein the measuring signal has a power of at most 1 watt.

### Reference Temperature Data Set

M39. The method according to any of the preceding embodiments and with the features of embodiment M23, wherein providing a reference data set (35) comprises

providing a reference temperature data set (35) related to the heating element (130).
M40. The method according to the preceding embodiment, wherein the reference temperature data set (35) comprises a plurality of reference temperature values indicating the expected temperature of the heating element (130) if heating a fluid composed according to the reference composition.
M41. The method according to the two preceding embodiments, wherein providing a reference temperature data set (35) related to the heating element (130) comprises

measuring an electrical resistance of a heating element (130) while heating a fluid composed according to the reference composition and

calculating a temperature of the heating element (130) based on the measured resistance of the heating element (130).
M42. The method according to the preceding embodiment, wherein measuring an electrical resistance of the heating element (130) comprises

measuring the electrical resistance of the heating element (130) with an ohmmeter.
M43. The method according to any of the two preceding embodiments, wherein measuring an electrical resistance of the heating element (130) comprises

providing a power current and a measuring signal to the heating element (130) in an alternating pattern such that only one of the power current and the measuring signal passes through the heating element (130) at a time,

wherein the power current is provided to the heating element (130) for generating heat and the measuring signal is provided to the heating element (130) for measuring the electrical resistance of the heating element (130).
M44. The method according to the preceding embodiment, wherein the power current has a power of at least 2 wats and at most 250 watts.
M45. The method according to any of the two preceding embodiments, wherein the measuring signal has a power of at most 1 watt.
M46. The method according to any of the 7 preceding embodiments, wherein providing a reference temperature data set (35) related to the heating element (130) comprises measuring the temperature of a heating element (130) while heating a fluid composed according to the reference composition.

### Measured Temperature Data Set

M47. The method according to any of the preceding embodiments and with the features of embodiment M23, wherein generating a measured data set (55) comprises

generating a measured temperature data set (55) related to the heating element (130).
M48. The method according to the preceding embodiment, wherein the measured temperature data set (55) comprises a plurality of temperature values indicating the temperature of the heating element (130) while heating the fluid in the fluid container (10).
M49. The method according to any of the two preceding embodiments and with the features of embodiment M15, wherein generating a measured temperature data set (55) related to the heating element (130) comprises

the measuring device (50) measuring the electrical resistance of the heating element (130) while heating the fluid in the fluid container (10) and

calculating a temperature of the heating element (130) based on the measured resistance of the heating element (130).
M50. The method according to the preceding embodiment, wherein the measuring device (50) comprises an ohmmeter.
M51. The method according to any of the two preceding embodiments, wherein measuring the electrical resistance of the heating element (130) comprises

providing a power current and a measuring signal to the heating element (130) in an alternating pattern such that only one of the power current and the measuring signal passes through the heating element (130) at a time,

wherein the power current is provided to the heating element (130) for generating heat and the measuring signal is provided to the heating element (130) for measuring the electrical resistance of the heating element (130).
M52. The method according to the preceding embodiment, wherein the power current has a power of at least 2 wats and at most 250 watts.
M53. The method according to any of the two preceding embodiments, wherein the measuring signal has a power of at most 1 watt.
M54. The method according to any of the 7 preceding embodiments, wherein generating a measured temperature data set (55) related to the heating element (130) comprises

the measuring device (50) measuring the temperature of the heating element (130) while heating the fluid in the fluid container (10).
M55. The method according to any of the 8 preceding embodiments and with the features of embodiment M15, wherein the measuring device (50) comprises at least one of

a thermistor, thermocouple, resistance thermometer and silicon bandgap temperature sensor.
M56. The method according to any of the 9 preceding embodiments and with the features of embodiment M15, wherein the heating element (130) and the measuring device (50) are parts of a thermistor or a resistance thermometer.

### Reference Thermal Capacity Data Set

M57. The method according to any of the preceding embodiments, wherein providing a reference data set (35) comprises

providing a reference thermal capacity data set (35) related to a fluid composed according to the reference composition.
M58. The method according to the preceding embodiment, wherein the reference thermal capacity data set (35) comprises a plurality of reference thermal capacity values each indicating an expected thermal capacity of the fluid in the fluid container (10) if composed according to the reference composition.
M59. The method according to the preceding embodiment, wherein each thermal capacity value in the reference thermal capacity data set (35) indicates an expected thermal capacity of the fluid in the fluid container (10) if composed according to the reference composition while the fluid is at certain temperature.
M60. The method according to any of the 3 preceding embodiments and with the features of embodiment M23, wherein providing a reference thermal capacity data set (35) comprises

measuring at least one temperature of a heating element (130) while heating a fluid composed according to the reference composition, and

calculating based on the at least one measured temperature of the heating element (130) at least one thermal capacity of the fluid composed according to the reference composition, and

generating the reference thermal capacity data set (35) based on the at least one calculated thermal capacity of the fluid composed according to the reference composition.
M61. The method according to any of the 4 preceding embodiments, wherein providing a reference thermal capacity data set (35) comprises

measuring at least one temperature of a fluid composed according to the reference composition while heating the fluid composed according to the reference composition, and

calculating based on the at least one measured temperature of the fluid composed according to the reference composition at least one thermal capacity of the fluid composed according to the reference composition, and

generating the reference thermal capacity data set (35) based on the at least one calculated thermal capacity of the fluid composed according to the reference composition.

### Measured Thermal Capacity Data Set (55)

M62. The method according to any of the preceding embodiments, wherein generating a measured data set (55) comprises

generating a measured thermal capacity data set (55) related to the fluid in the fluid container (10).
M63. The method according to the preceding embodiment, wherein the measured thermal capacity data set (55) comprises a plurality of thermal capacity values indicating the thermal capacity of the fluid in the fluid container (10).
M64. The method according to the preceding embodiment, wherein each thermal capacity value indicates the thermal capacity of the fluid in the fluid container (10) while the fluid is at a certain temperature.
M65. The method according to any of the three preceding embodiments and with the features of embodiment M23, wherein generating a measured thermal capacity data set (55) comprises

measuring at least one temperature of the heating element (130) while heating the fluid in the fluid container (10), and

calculating based on the at least one measured temperature of the heating element (130) at least one thermal capacity of the fluid in the fluid container (10), and

generating the measured thermal capacity data set (55) based on the at least one calculated thermal capacity of the fluid in the fluid container (10).
M66. The method according to any of the four preceding embodiments, wherein generating a measured thermal capacity data set (55) comprises

measuring at least one temperature of the fluid in the fluid container (10) while heating the fluid in the fluid container (10), and

calculating based on the at least one measured temperature of the fluid in the fluid container (10) at least one thermal capacity of the fluid in the fluid container (10), and

generating the measured thermal capacity data set (55) based on the at least one calculated thermal capacity of the fluid in the fluid container (10).

### First/Second Components

M67. The method according to any of the preceding embodiments, the method comprising providing a first component (520A) and a second component (520B) at a distance from each other and internally to the fluid container (10).
M68. The method according to the preceding embodiment and with the features of embodiment M15, wherein the first component (520A) and the second component (520B) are connected with the measuring device (50).

### Reference Fluid Electrical Resistance

M69. The method according to any of the preceding embodiments and with the features of embodiment M67, wherein the first component (520A) and the second component (520B) respectively comprise at least one electrode.
M70. The method according to the preceding embodiment, wherein providing a reference data set (35) comprises

providing a reference fluid electrical resistance data set (35) related to a fluid composed according to the reference composition.
M71. The method according to the preceding embodiment, wherein the reference fluid electrical resistance data set (35) comprises a plurality of reference fluid electrical resistance values indicating the expected electrical resistance of the fluid in the fluid container (10) if composed according to the reference composition.
M72. The method according to any of the two preceding embodiments, wherein providing a reference fluid electrical resistance data set (35) comprises

measuring the electrical resistance of a fluid composed according to the reference composition.
M73. The method according to the preceding embodiment, wherein measuring the electrical resistance of the fluid composed according to the reference composition

measuring the electrical resistance of the fluid composed according to the reference composition with an ohmmeter connected to a reference first component (520A) and to a reference second component (520B), both immersed in the fluid composed according to the reference composition.

### Measured Fluid Electrical Resistance Data Set

M74. The method according to any of the preceding embodiments the features of embodiment M67, wherein generating a measured data set (55) comprises

generating a measured fluid electrical resistance data set (55) related to the fluid in the fluid container (10).
M75. The method according to the preceding embodiment, wherein the measured fluid electrical resistance data set (55) comprises a plurality of fluid electrical resistance values corresponding to the electrical resistance of the fluid in the fluid container (10).
M76. The method according to any of the two preceding embodiments and with the features of embodiment M15, wherein generating a measured fluid electrical resistance data set (55) related to the heating element (130) comprises the measuring device (50) measuring the electrical resistance of the fluid in the fluid container (10).
M77. The method according to the preceding embodiment, wherein the measuring device (50) comprises an ohmmeter connected to the first component (520A) and second component (520B).

### Refractive Index

M78. The method according to any of the preceding embodiments and with the features of embodiment M67, wherein

the first component (520A) emits a measuring signal, preferably an electromagnetic wave with a narrow beam-width, such as, a laser beam and

the second component (520B) receives the measuring signal after the measuring signal propagates through the fluid in the fluid container (10) and at least one other medium.

### Reference Refractive Index Data Set

M79. The method according to any of the preceding embodiments and with the features of embodiment M78, wherein providing the reference data set (35) comprises

providing a reference refractive index data set (35) related to a fluid composed according to the reference composition.
M80. The method according to the preceding embodiment, wherein the measured refractive index data set (55) comprises at least one refractive index value each indicating an expected refractive index of the fluid in the fluid container (10) if composed according to the reference composition.
M81. The method according to any of the two preceding embodiments and with the features of embodiment M15, wherein providing a measured refractive index data set (35) comprises

measuring a refractive index of a fluid composed according to the reference composition.

### Measured Refractive Index Data Set

M82. The method according to any of the preceding embodiments and with the features of embodiment M78, wherein generating the measured data set (55) comprises generating a measured refractive index data set (55) related to the fluid in the fluid container.
M83. The method according to the preceding embodiment, wherein the measured refractive index data set (55) comprises at least one refractive index value indicating the refractive index of the fluid in the fluid container (10).
M84. The method according to any of the two preceding embodiments and with the features of embodiment M15, wherein generating a measured refractive index data set (55) comprises the measuring device (50) measuring a refractive index of the fluid in the fluid container (10).
M85. The method according to the preceding embodiment, wherein the measuring device (50) measuring a refractive index of the fluid in the fluid container comprises

configuring the second component (520B) to indicate a position of incidence of the measuring signal and

determining the refractive index of the fluid in the fluid container based on the position of incidence of the measuring signal.
M86. The method according to the preceding embodiment, wherein the second component (520B) comprises a plurality of detection elements each configured to change a respective detection element property when the measuring signal is incident on the detection element.

### Reference Composition

M87. The method according to any of the preceding embodiments, wherein the reference composition of the fluid refers to the intended, expected and/or required composition of the fluid.
M88. The method according to any of the preceding embodiments, wherein the reference composition relates to a list of chemical elements and/or chemical compounds that are intended, expected and/or required to be in the fluid.
M89. The method according to the preceding embodiments, wherein the reference data set (35) further comprises for each chemical elements and/or chemical compounds in the list of chemical elements and/or chemical compounds intended, expected and/or required to be in the fluid

a respective portion that the chemical elements and/or chemical compounds is intended, expected and/or required to be in the fluid.

### Properties

M90. The method according to the preceding embodiment, wherein the measured data set (55) indicate

a thermal capacity of the fluid in the fluid container (10),

an electrical conductivity of the fluid in the fluid container (10),

an electrical resistance of the fluid in the fluid container (10),

a magnetic permeability of the fluid in the fluid container (10),

a refractive index of the fluid in the fluid container (10),

an acidity measure of the fluid in the fluid container (10),

an alkalinity measure of the fluid in the fluid container (10)

a spectroscopic measurement of the fluid,

or any combination thereof.
M91. The method according to the preceding embodiment, wherein the reference data set (55) indicate

an expected thermal capacity of the fluid in the fluid container (10) if composed according to the reference composition,

an expected electrical conductivity of the fluid in the fluid container (10) if composed according to the reference composition,

an expected electrical resistance of the fluid in the fluid container (10) if composed according to the reference composition,

an expected magnetic permeability of the fluid in the fluid container (10) if composed according to the reference composition,

an expected refractive index of the fluid in the fluid container (10) if composed according to the reference composition,

an expected acidity measure of the fluid in the fluid container (10) if composed according to the reference composition,

an expected alkalinity measure of the fluid in the fluid container (10) if composed according to the reference composition,

an expected spectroscopic measure of the fluid if composed according to the reference composition,

or any combination thereof.

### Mobile Inhaler

M92. The method according to any of the preceding embodiment, wherein the fluid is a liquid, liquid solution, gas, aerosol, vapor used in a mobile inhaler (20), such as, in an e-cigarette (20).
M93. The method according to any of the preceding embodiments, wherein the fluid container (10) is part of a mobile inhaler (20), such as, an e-cigarette (20).
M94. The method according to any of the preceding embodiments, wherein the fluid container (10) is attached to a mobile inhaler (20), such as, an e-cigarette (20).
M95. The method according to any of the preceding embodiments, wherein the method is used to detect contamination of a fluid used by a mobile inhaler (20), such as, an e-cigarette
M96. A method for detecting contamination of a fluid in at least one fluid container (10) of a mobile inhaler (20) according to any of the preceding method embodiments.
M97. The method according to nay of the preceding embodiments, wherein the method is a computer implemented method.
M98. The method according to nay of the preceding embodiments, wherein the method is a computer program product.

Below, use embodiments will be discussed. These embodiments are identified by the letter U followed by a number. When reference is herein made to use embodiments, these embodiments are meant.
U1. Use the method according to any of the preceding method embodiments, to detect contamination of a fluid in a fluid container (10).
U2. Use of the method according to any of the preceding method embodiments, to detect contamination of a fluid in at least one fluid container (10) of a mobile inhaler (20).

Below, system embodiments will be discussed. These embodiments are identified by the letter S followed by a number. When reference is herein made to system embodiments, these embodiments are meant.
S1. A system configured to detect contamination of a fluid in a fluid container (10) comprising

a fluid container (10) configured to be at least partly filled with a fluid;

a memory component (30) configured to store a reference data set (35) related to a reference composition of the fluid;

a measuring device (50) configured to generate a measured data set (55) related to the composition of the fluid;

a processing unit configured to
compare the measured data set (55) with the reference data set (35) and
determine based on the comparison whether the fluid is contaminated.
S2. The system according to the preceding embodiment, wherein the fluid container (10) comprises at least one reservoir, each configured to contain a fluid.
S3. The system according to any of the preceding system embodiments, wherein the measuring device (50) is configured to measure at least one of

a physical property depending on the composition of the fluid in the fluid container (10), such as, a thermal property, an electrical property, an acoustical property, a magnetic property and an optical property,

a chemical property depending on the composition of a fluid the fluid in the fluid container (10), such as, composition, acidity and alkalinity,

or any combination thereof.
S4. The system according to any of the preceding system embodiments, wherein the fluid in the fluid container (10) is a fluid to be tested for contamination.
S5. The system according to any of the preceding system embodiments, wherein the fluid in the fluid container (10) is a non-contaminated fluid composed according to the reference composition and the system is used to generate the reference data set (35).
S6. The system according to any of the preceding system embodiments, wherein the processing unit (40) comprises one or more processors or processing cores, such as, at least one CPU (central processing unit), at least one GPU (graphical processing unit), at least one DSP (digital signal processor), at least one APU (accelerator processing unit), at least one ASIC (application-specific integrated circuit), at least one ASIP (application-specific instruction-set processor), at least one FPGA (field programable gate array) or any combination thereof.
S7. The system according to any of the preceding system embodiments, wherein the memory component (30) comprises a volatile and/or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), Parameter RAM (P-RAM), solid-state drive or any combination thereof.
S8. The system according to any of the preceding system embodiments, wherein the processing unit (40) can be configured to send and receive data to/from the memory component (30).
S9. The system according to any of the preceding system embodiments, wherein the processing unit (40) and the measuring device (50) are configured for data communication with each other.
S10. The system according to any of the preceding system embodiments, further comprising an indication unit (60) configured to output an indication of the determination whether the fluid in the fluid container (10) is contaminated.
S11. The system according to the preceding embodiment, wherein the indication is a visual, audio and/or haptic indication.
S12. The system according to any of the preceding system embodiments, wherein the system further comprises a heating element (130) internal to the fluid container (10) configured to heat the fluid in the fluid container (10) by generating heat.
S13. The system according to the preceding embodiment, wherein the heating element (130) comprises at least one resistor, at least one inductor or any combination thereof.
S14. The system according to any of the two preceding embodiments, wherein the system comprises at least one signal guider (510) configured to electrically connect the measuring device (50) with the heating element (130).
S15. The system according to the preceding embodiment, wherein the signal guider (510) comprises an electrical wire.
S16. The system according to any of the preceding system embodiments, wherein the measuring device (50) comprises at least one of

ohmmeter, a thermistor, thermocouple, resistance thermometer and silicon bandgap temperature sensor, thermometer.
S17. The system according to the preceding embodiment, wherein the measuring device (50) is configured to measure a temperature of the fluid in the fluid container.
S18. The system according to any of the 2 preceding embodiments, wherein the measuring device (50) is configured to measure a thermal capacity of the fluid in the fluid container.
S19. The system according to any of the 3 preceding embodiments and with the features of embodiment 513, wherein the measuring device (50) is configured to measure an electrical resistance of the heating element (130).
S20. The system according to any of the preceding system embodiments, further comprising a first component (520A) and a second component (520B) at a distance from each other and internally to the fluid container (10).
S21. The system according to the preceding embodiment, wherein the system comprises

at least one signal guider (510) configured to electrically connect the measuring device (50) with the first component (520A) and

at least one signal guider (510) configured to electrically connect the measuring device (50) with the second component (520B).
S22. The system according to any of the two preceding embodiments, wherein the first component (520A) and the second component (520B) comprise at least one electrode, respectively.
S23. The system according to the preceding embodiment, wherein the measuring device (50) is configured to measure an electrical resistance of the fluid in the fluid container (10).
S24. The system according to any of the 4 preceding embodiments, wherein

the first component (520A) is configured to emit a measuring signal, preferably an electromagnetic wave with a narrow beam-width, such as, a laser beam and

the second component (520B) is configured to receive the measuring signal after the measuring signal propagates through the fluid in the fluid container (10) and at least one other medium.
S25. The system according to the preceding embodiment, wherein

the first component (520A) comprises at least one of an electromagnetic wave transmitting antenna, light source, laser, LED or any combination thereof, and

the second component (520B) comprises at least one of an electromagnetic wave receiver, electromagnetic wave detector, light sensor, optical sensor, image sensor or any combination thereof.
S26. The system according to any of the 2 preceding embodiments, wherein the system further comprises a collimator lens configured to focus the electromagnetic wave emitted by the first component (520A).
S27. The system according to any of the 3 preceding embodiments, wherein the electromagnetic wave emitted by the first component (520A) comprises a wavelength between 300 nanometers to 1 millimeter, preferably between, 300 nanometers to 700 nanometers.
S28. The system according to any of the 4 preceding embodiments, wherein the measuring device is configured to measure a refractive index of the fluid in the fluid container.
S29. The system according to any of the preceding system embodiments further comprising a mobile inhaler (20), such as, an e-cigarette (20) and wherein the fluid container (10) is attached to the mobile inhaler (20), in a releasable or non-releasable manner.
S30. The system according to the preceding embodiment, wherein the mobile inhaler (20) comprises a mouthpiece (254) that is configured to be taken into the mouth of a user of the mobile inhaler (20).
S31. The system according to the preceding embodiment, wherein the mobile inhaler (20) comprises at least one canal (255) configured to guide a fluid, such as, a vapor, from the fluid container (10) to the mouthpiece (254).
S32. The system according to any of the 3 preceding embodiments, wherein the mobile inhaler (20) comprises an energy storage component (270).
S33. The system according to any of the preceding embodiments, wherein the system further comprises a database configured to store at least one reference data set (35).
S34. The system according to the preceding embodiment, wherein the processing unit (40) and the database are configured for data communication.
S35. The method according to any of the 2 preceding embodiments, wherein the processing unit (40) is configured to send at least one database query to the database and the database is configured to send data to the processing unit (40).
S36. The system according to any of the preceding embodiments, wherein the system is configured to carry out the method according to any of the preceding method embodiments.
S37. A system for detecting contamination of a fluid in at least one fluid container (10) of a mobile inhaler (20) according to any of the preceding system embodiments.

U3. Use of the system according to any of the preceding method embodiments, to detect contamination of a fluid in a fluid container (10).

U4. Use of the system according to any of the preceding method embodiments, to detect contamination of a fluid in at least one fluid container (10) of a mobile inhaler (20).

Below, device embodiments will be discussed. These embodiments are identified by the letter D followed by a number. When reference is herein made to device embodiments, these embodiments are meant.
D1. A mobile inhaler (20) comprising

at least one fluid container (10) configured to be at least partly filled with a fluid;

a memory component (30) configured to store a reference data set (35) related to a reference composition of the fluid;

a measuring device (50) configured to generate a measured data set (55) related to the composition of the fluid;
a processing unit (40) configured to

compare the measured data set (55) with the reference data set (35) and

determine based on the comparison whether the fluid is contaminated.
D2. The mobile inhaler (20) according to the preceding embodiment, wherein each of the fluid containers (10) comprises at least one reservoir, each configured to contain a fluid, such as, an e-liquid.
D3. The mobile inhaler (20) according to any of the preceding device embodiments, wherein the measuring device (50) is configured to measure at least one of

a physical property depending on the composition of the fluid in the fluid container (10), such as, a thermal property, an electrical property, an acoustical property, a magnetic property and an optical property,

a chemical property depending on the composition of a fluid the fluid in the fluid container (10), such as, composition, acidity and alkalinity,

or any combination thereof.
D4. The mobile inhaler (20) according to any of the preceding device embodiments, wherein the fluid in the fluid container (10) is a fluid to be tested for contamination.
D5. The mobile inhaler (20) according to any of the preceding device embodiments, wherein the fluid in the fluid container (10) is a non-contaminated fluid composed according to the reference composition and the mobile inhaler (20) is used to generate the reference data set (35).
D6. The mobile inhaler (20) according to any of the preceding device embodiments, wherein the processing unit (40) comprises one or more processors or processing cores, such as, at least one CPU (central processing unit), at least one GPU (graphical processing unit), at least one DSP (digital signal processor), at least one APU (accelerator processing unit), at least one ASIC (application-specific integrated circuit), at least one ASIP (application-specific instruction-set processor), at least one FPGA (field programable gate array) or any combination thereof.
D7. The mobile inhaler (20) according to any of the preceding device embodiments, wherein the memory component (30) comprises a volatile and/or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), Parameter RAM (P-RAM), solid-state drive or any combination thereof.
D8. The mobile inhaler (20) according to any of the preceding device embodiments, wherein the processing unit (40) can be configured to send and receive data to/from the memory component (30).
D9. The mobile inhaler (20) according to any of the preceding device embodiments, wherein the processing unit (40) and the measuring device (50) are configured for data communication with each other.
D10. The mobile inhaler (20) according to any of the preceding device embodiments, further comprising an indication unit (60) configured to output an indication of the determination whether the fluid in the fluid container (10) is contaminated.
D11. The mobile inhaler (20) according to the preceding embodiment, wherein the indication is a visual, audio and/or haptic indication.
D12. The mobile inhaler (20) according to any of the preceding device embodiments, wherein the mobile inhaler (20) further comprises a heating element (130) internal to the fluid container (10) configured to heat the fluid in the fluid container (10) by generating heat.
D13. The mobile inhaler (20) according to the preceding embodiment, wherein the heating element (130) comprises at least one resistor, at least one inductor or any combination thereof.
D14. The mobile inhaler (20) according to any of the two preceding embodiments, wherein the mobile inhaler (20) comprises at least one signal guider (510) configured to electrically connect the measuring device (50) with the heating element (130).
D15. The mobile inhaler (20) according to the preceding embodiment, wherein the signal guider (510) comprises an electrical wire.
D16. The mobile inhaler (20) according to any of the preceding device embodiments, wherein the measuring device (50) comprises at least one of

ohmmeter, a thermistor, thermocouple, resistance thermometer and silicon bandgap temperature sensor, thermometer.
D17. The mobile inhaler (20) according to the preceding embodiment, wherein the measuring device (50) is configured to measure a temperature of the fluid in the fluid container.
D18. The mobile inhaler (20) according to any of the 2 preceding embodiments, wherein the measuring device (50) is configured to measure a thermal capacity of the fluid in the fluid container.
D19. The mobile inhaler (20) according to any of the 3 preceding embodiments and with the features of embodiment 513, wherein the measuring device (50) is configured to measure an electrical resistance of the heating element (130).
D20. The mobile inhaler (20) according to any of the preceding device embodiments, further comprising a first component (520A) and a second component (520B) at a distance from each other and internally to the fluid container (10).
D21. The mobile inhaler (20) according to the preceding embodiment, wherein the mobile inhaler (20) comprises

at least one signal guider (510) configured to electrically connect the measuring device (50) with the first component (520A) and

at least one signal guider (510) configured to electrically connect the measuring device (50) with the second component (520B).
D22. The mobile inhaler (20) according to any of the two preceding embodiments, wherein the first component (520A) and the second component (520B) comprise at least one electrode, respectively.
D23. The mobile inhaler (20) according to the preceding embodiment, wherein the measuring device (50) is configured to measure an electrical resistance of the fluid in the fluid container (10).
D24. The mobile inhaler (20) according to any of the 4 preceding embodiments, wherein

the first component (520A) is configured to emit a measuring signal, preferably an electromagnetic wave with a narrow beam-width, such as, a laser beam and

the second component (520B) is configured to receive the measuring signal after the measuring signal propagates through the fluid in the fluid container (10) and at least one other medium.
D25. The mobile inhaler (20) according to the preceding embodiment, wherein

the first component (520A) comprises at least one of an electromagnetic wave transmitting antenna, light source, laser, LED or any combination thereof, and

the second component (520B) comprises at least one of an electromagnetic wave receiver, electromagnetic wave detector, light sensor, optical sensor, image sensor or any combination thereof.
D26. The mobile inhaler (20) according to any of the 2 preceding embodiments, wherein the mobile inhaler (20) further comprises a collimator lens configured to focus the electromagnetic wave emitted by the first component (520A).
D27. The mobile inhaler (20) according to any of the 3 preceding embodiments, wherein electromagnetic wave emitted by the first component (520A) comprises a wavelength between 300 nanometers to 1 millimeter, preferably between, 300 nanometers to 700 nanometers.
D28. The mobile inhaler (20) according to any of the 4 preceding embodiments, wherein the measuring device is configured to measure a refractive index of the fluid in the fluid container.
D29. The mobile inhaler (20) according to any of the preceding device embodiments wherein the fluid container (10) is attached to the mobile inhaler (20), in a releasable or non-releasable manner.
D30. The mobile inhaler (20) according to any of the preceding embodiments, wherein the mobile inhaler (20) comprises a mouthpiece (254) that is configured to be taken into the mouth of a user of the mobile inhaler (20).
D31. The mobile inhaler (20) according to the preceding embodiment, wherein the mobile inhaler (20) comprises at least one canal (255) configured to guide a fluid, such as, a vapor, from the fluid container (10) to the mouthpiece (254).
D32. The mobile inhaler (20) according to any of the 3 preceding embodiments, wherein the mobile inhaler (20) comprises an energy storage component (270), such as, a battery (270).
D33. The mobile inhaler (20) according to any of the preceding embodiments, wherein the mobile inhaler (20) is further configured to transfer data with a database configured to store at least one reference data set (35).
D34. The mobile inhaler (20) according to the preceding embodiment, wherein the processing unit (40) and the database are configured for data communication.
D35. The method according to any of the 2 preceding embodiments, wherein the processing unit (40) is configured to send at least one database query to the database and the database is configured to send data to the processing unit (40).
D36. The mobile inhaler (20) according to any of the preceding embodiments, configured to allow a fluid in a fluid container (10) to be delivered to a user, if the processing unit determines that the fluid is not contaminated.
D37. The mobile inhaler (20) according to any of the preceding embodiments, wherein the mobile inhaler (20) is configured to carry out the method according to any of the preceding method embodiments.
D38. The mobile inhaler (20) according to the preceding embodiment, wherein the mobile inhaler (20) is configured to detect contamination of the fluid in the at least one fluid container (10).

### BRIEF DESCRIPTION OF THE DRAWINGS

FIG. 1 depicts a method for detecting contamination of a fluid in a fluid container;

FIG. 2 illustrates a system configured to detect contamination of a fluid in a fluid container;

FIGS. 3a to 3d illustrate a mobile inhaler and a fluid container configured to detect contamination of a fluid in a fluid container;

FIGS. 4a and 4b depict a schematic of a measuring device and fluid container configured to detect contamination of a fluid in a fluid container;

FIGS. 4c and 4d illustrate an embodiment of the method for detecting contamination of a fluid in a fluid container;

FIGS. 4e to 4f illustrate another embodiment of the method for detecting contamination of a fluid in a fluid container;

FIGS. 5a to 5d illustrate further embodiments of a measuring device and fluid container configured to detect contamination of a fluid in a fluid container;

FIG. 6 illustrates an embodiment wherein a fluid sensor can be provided internal to the fluid container;

FIG. 7a illustrates an exemplary reference data set;

FIG. 7b illustrates two exemplary temperature data sets.

### DETAILED DESCRIPTION OF THE DRAWINGS

In the following, exemplary embodiments of the invention will be described, referring to the figures. These examples are provided to give further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps can be present between some or all of the described steps.

The present invention generally relates to the detection of contamination of a fluid in a fluid container.

The term fluid, as used throughout the text, may refer to liquids and gases. More particularly, the term fluid may refer to a liquid, liquid solution, gas, aerosol, vapor, the liquid used in an e-cigarette, also referred to as an e-liquid or e-juice, the vapor produced after heating the e-liquid or any combination thereof. For example, the fluid can refer to a mixture comprising propylene glycol, glycerin, water, flavorings and nicotine.

In addition, the fluid may comprise one or more contaminants. A contaminant can refer to a substance, which can be a chemical element or compound, which is not intended, expected and/or required to be in the fluid. A contaminant can also refer to a microbiological contaminant, i.e., microorganisms. That is, a fluid can be contaminated if it comprises substances and/or microorganisms not intended to be in the fluid. Additionally or alternatively, a fluid can be contaminated if it comprises a substance or microorganism that is intended to be in the fluid but it is in an excess amount, i.e., more than intended. In such cases, the excess amount of the substance or microorganism can be referred to as a contaminant.

Contamination in a fluid can refer to the presence of at least one contaminant on a fluid. As such, detecting contamination in a fluid can refer to detecting the presence of at least one contaminant in a fluid.

In other words, a fluid is contaminated if its composition is different (i.e. differentiates, deviates) from a reference composition of the fluid. The reference composition of a fluid may refer to the intended, expected and/or required composition of the fluid. The reference composition of a fluid may refer to a list of substances and/or microorganisms intended to be in a fluid. All other substances and/or microorganisms may be referred to as contaminants. In addition, the reference composition of a fluid may also refer to amounts or portions of substances and/or microorganisms intended to be in a fluid. In this case, also the excess amount of the substances and/or microorganisms intended to be in the fluid, in addition to other substances and/or microorganisms not intended to be in the fluid, may be referred to as contaminants.

Embodiments of the present invention, are particularly advantageous for improving mobile inhalers, such as, e-cigarettes. That is, the fluid container can be part of or attached to a mobile inhaler. In such embodiments, the container may also be referred to as e-cigarette cartridge, e-cigarette refill or simply as cartridge.

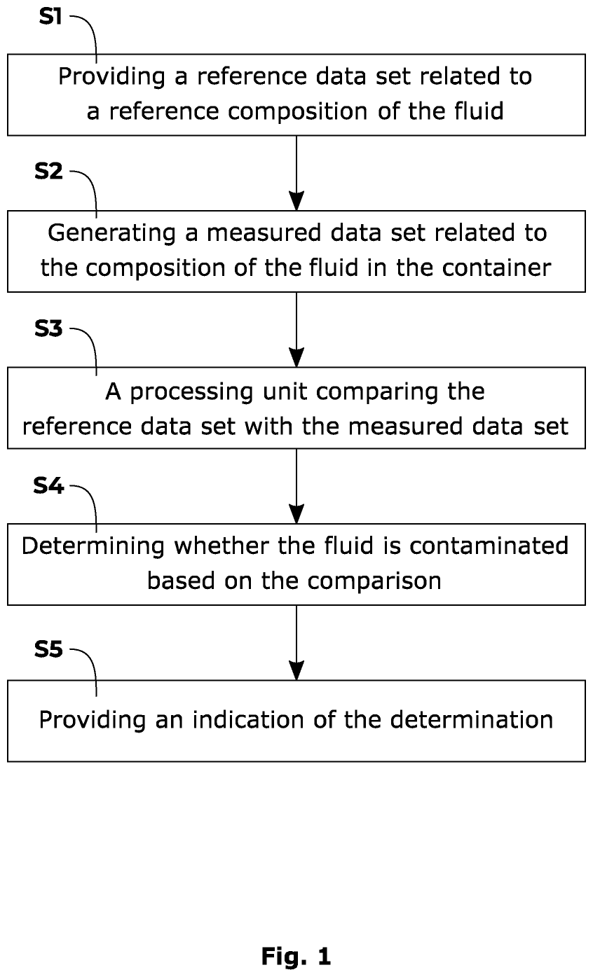

In FIG. 1, an embodiment of a method for detecting contamination in a fluid is depicted.

In a step S1, the method comprises providing a reference data set related to or indicating a reference composition of the fluid. The reference composition of a fluid may refer to the intended, expected and/or required composition of the fluid. The reference composition of a fluid may refer to a list of substances and/or microorganisms intended to be in the fluid. All other substances and/or microorganisms may be referred to as contaminants. In addition, the reference composition of a fluid may also refer to amounts or portions of substances and/or microorganisms intended to be in the fluid. In this case, also the excess amount of the substances and/or microorganisms intended to be in the fluid, in addition to other substances and/or microorganisms not intended to be in the fluid, may be referred to as contaminants.

The reference data set that can correspond to a fluid can be generated by measuring a property of the fluid composed according to the reference composition. For example, the reference data set can be generated by measuring a property of a fluid comprising or composed according to the reference composition that is not contaminated. That is, a reference fluid can be produced, said reference fluid being composed according to the reference composition. To decrease the likelihood and/or amount of contamination the reference fluid may be produced and handled in a more specialized way, such as, in a specialized laboratory. By measuring one or more properties of the reference fluid, the reference data set can be generated.

In some embodiments, the reference data set can be inferred (e.g. through calculations) based on the reference composition of the fluid. That is, based on known properties of the constituents (e.g. atoms, molecules) composing the fluid, the reference data set can be inferred.

In addition, the reference data set may further comprise data generated by performing a measurement without the presence of the fluid, e.g., by performing the same type of measurement performed to the reference fluid, without the presence of the reference fluid. As such, the reference data set may comprise a range between the data generated by performing a measurement without the presence of the fluid (also referred to as a dry measurement) and the data generated by performing a measurement of the reference fluid (also referred to as a wet measurement).

In a step S2, the method can comprise generating a measured data set related to or indicating the composition of the fluid in the container, also referred to as an actual composition of the fluid. The actual composition of the fluid may refer to the substances and/or microorganisms that are present in the fluid during the generation of the measured data set in step S2.

The measured data set may relate to or indicate a property of the fluid in the fluid container. Moreover, the measured data set and the reference data set can correspond to each other. That is, the measured data set and the reference data set can refer to same or similar properties of the fluid. In some embodiments, the measured data set may not directly relate to the same property of the fluid that the reference data set relates to. However, the measured data set may relate to a measurable property of the fluid based on which the property of the fluid that the reference data set relates to can be determined. In other words, step S2 may comprise a sub-step wherein a measurable property of the fluid can be used to determine a property of the fluid such that the reference data set also relates to the said property. In other words, measuring a property of the fluid may comprise measuring a measurable property of the fluid and based thereon determining the property of the fluid.

For example, in some embodiments, the reference data set can comprise raw reference data (e.g. as output by a sensor with no or little processing). Correspondingly, the measured data set can comprise raw measured data (e.g. as output by a sensor with no or little processing). In such embodiments, the reference data set and the measured data set directly correspond to each other. Hence, they can be directly compared to each other without further processing.

Alternatively, in some embodiments, the reference data set can comprise reference data, which can refer to data obtained after processing of raw reference data. Said reference data can describe or related to a property of the reference fluid more directly than the raw reference data. For example, the raw reference data may comprise a plurality of electrical resistance values of a heating element submerged in the reference fluid and the reference data can comprise thermal capacity values of the reference fluid calculated based on the resistance values. In such embodiments, the measured data set can correspondingly comprise measured data set obtained after processing raw measured data. That is, after obtaining raw measured data they can be processed to obtain measured data, which can then be compared with the reference data.

Put simply, the reference data set and the measured data set can comprise data that can be compared with each other. For example, the reference data set and the measured data set may comprise same units (or units that can be converted to each other) and/or same dimensions. That is, the reference data set and the measured data set may be represented with identical or similar data structures (e.g. integers, strings, lists, arrays, 2D-arrays, multi-dimensional arrays, matrices). In some embodiments, the reference data set and the measured data set may comprise time series, such as, time series of the same quantity.

It will be understood, that the fluid in the fluid container, which property can be measured in step S2, is intended to comprise the same composition as the reference composition. That is, ideally the fluid in the fluid container can be composed according to the reference composition. In other words, the reference composition of the fluid in step S1 corresponds to the composition of the fluid in the fluid container. Put simply, the fluid in the fluid container in step S2 is intended to be composed according to the reference composition in step S1. However, due to contamination the fluid in the fluid container may comprise contaminants.

For example, the fluid in the fluid container may comprise substances and/or microorganisms not intended to be in the fluid. Similarly, the fluid in the fluid container may comprise substances and/or microorganisms intended to be in the fluid but in a different amount than intended to. That is, the fluid in the fluid container can be contaminated.

In a step S3, the method can comprise providing a processing unit and the processing unit comparing the reference data set with the measured data set. As discussed, above the reference data set and the measured data set can be configured to be comparable with each other. As such, the processing unit can compare the measured data set with the reference data set.

During step S3, the similarity (or dissimilarity) between the reference data set and the measure data set can be determined. That is, one or more distance metrics can be calculated, which can take larger values with increasing difference between the reference data set and the measured data set. In this regard, different similarity measures can be utilized.

In some embodiments, in step S3 individual elements in the reference data set can be compared with respective individual elements in the measured data set. For example, a norm between the reference data set and the measured data set (e.g. L1 norm, L2 norm, Huber norm) can be calculated. The norm can then be used to assess the similarity of the measured data set with the reference data set. Alternatively or additionally, a correlation between the reference data set and the measured data set can be calculated during step S3.

In some embodiments, in step S3 a metric (e.g. mean, standard deviation, variance, distribution or the like) corresponding to the reference data set can be calculated and a respective metric corresponding to the measured data set can be calculated. Then the comparison can be performed by comparing the two calculated measures.

In some embodiments, in step S3 a distribution of the reference data set can be calculated (or comprised therein) and a corresponding distribution of the measured data set can be calculated. The comparison in step S3 can be performed by comparing the two distributions, e.g., using a goodness of fit test, the Kolmogorov-Smirnov test, Z-test.

It will be understood, that the above are only some examples of algorithms to compare the reference data set and a measured data set. In general, during step S3 a comparison function can be defined. The comparison function can receive as an input the reference data set and the measured data set and can output a distance metric which can indicate the similarity between the reference data set and the measured data set. The distance metric may be a binary metric, discrete metric or continuous metric. The distance metric may take values within an interval, wherein one value in that interval can indicate that the measured data set and the reference data set are identical and at least one other value can indicate that the measured data set and the reference data set are different. In addition, the distance metric calculated during step S3 may quantitively indicate the dissimilarity between the measured data set and the reference data set.

In a step S4, the method can comprise determining whether the fluid is contaminated based on the comparison, e.g. based on the distance metric calculated in step S3. More particularly, if based on the comparison of step S3 it can be determined that the measured data set and the reference data set are different, then in step S4 it can be determined that the fluid is contaminated. Otherwise, it can be determined that the fluid is not contaminated. In addition, particularly if in step S3 the dissimilarity between the measured data set and the reference data set can be indicated quantitively (e.g. a value of the distance metric can be calculated), a level of contamination of the fluid can be determined based thereon.

In a step S5, an indication of the determination performed in step S4 can be provided. This can particularly be the case if in step S4 it is determined that the fluid is contaminated. Providing an indication may comprise raising an alarm, activating a speaker, a screen, an LED, deactivating a device (e.g. the mobile inhaler discussed further below), preventing the fluid from escaping the fluid container, activating a vibrating device for a haptic feedback or any combination thereof. Preferably, step S5 may comprise providing a feedback to a user or operator (e.g. the user of the mobile inhaler discussed further below) regarding the contamination state of the fluid in the fluid container and particularly when the fluid is contaminated. Step S5 may further comprise displaying a warning and/or a level of contamination which can be a number on a scale or a qualitative word (e.g. not contaminated, contaminated, heavily contaminated). This can be particularly advantageous for informing a user of a mobile inhaler when the fluid contained in the mobile inhaler that the user intends to inhale is contaminated. Thus, the method of the present invention prevents or at least reduces the risk of a user of a mobile inhaler inhaling contaminated fluids which can be hazardous to the health of the user of the mobile inhaler.

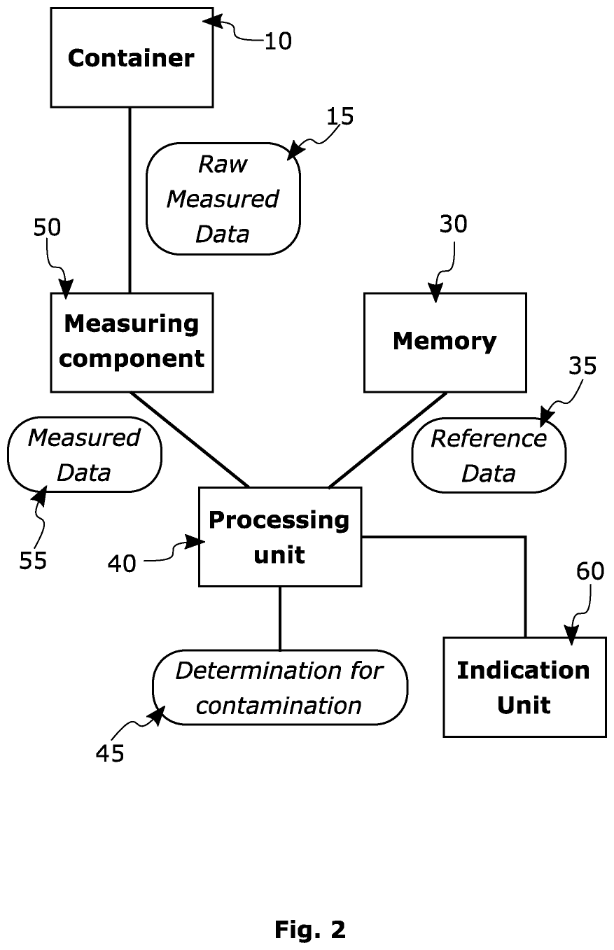

FIG. 2 schematically illustrates a system configured to detect contamination of a fluid in a fluid container. For example, the system can be configured for carrying out the method for detecting contamination of a fluid in a fluid container, as discussed with reference to FIG. 1. It will be understood that the system described in the following and the method discussed with reference to FIG. 1 share similar features. As such, all features of the method can correspond to the system and vice versa.

The system may comprise a fluid container 10. The fluid container 10 can be configured to contain a fluid. That is, the fluid container 10 may comprise a reservoir which can be filled with a fluid.

The system may further comprise a measuring device 50. The measuring device 50 can be configured to measure a property of the fluid in the fluid container 10. More particularly, the measuring device 50 can be configured to generate a measured data set 55 related to or indicating the composition of the fluid in the fluid container 10. The measured data set 55 can be measured directly by the measuring device 50 performing a measurement. Alternatively, the measuring device 50 may obtain raw measured data 15 by performing a measurement and based on the raw measured data 15 the measured data 55 can be generated. For example, the raw measured data 15 may comprise a plurality of electrical resistance values 15 of a heating element submerged in the fluid of the fluid container 10 and the measured data 55 can comprise thermal capacity values 55 of the fluid calculated based on the electrical resistance values. Exemplary embodiments of the measuring device 50 are discussed further below.

Further the system can comprise a processing unit 40. The processing unit 40 may be comprise one or more processors or processing cores, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programable gate array).

The measured data set 55 can be provided to the processing unit 40. In some embodiments, the measuring device 50 can provide the measured data set 55 to the processing unit 40. Alternatively, the measuring device 50 can provide raw measure data 15 to the processing unit 40 and the processing unit 40 can process the raw measured data 15 and generate based on the raw measured data 15 the measured data set 55.

Further the system can comprise a memory component 30. The memory component 30 may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The memory component 30 can be configured to store the reference data set 35.

The reference data set 35 can be provided from the memory component 30 to the processing unit 40.

The processing unit 40 can compare the measured data set 55 and the reference data set 35. Based on the comparison, the processing unit 40 can generate and/or output a determination for contamination 45 of the fluid in the fluid container 10.

The system may further comprise an indication unit 60 configured to output an indication of the determination for contamination 45 of the fluid in the fluid container 10.

The processing unit 40 can further be configured to control the measuring device 50 and/or the memory 30 and/or the indication unit 60. For example, the processing unit 40 may trigger the measuring device 50 to perform a measurement. The processing unit 40 can trigger the measuring device 50 to provide the raw measured data 15 and/or the measured data set 55. The processing unit 40 can further trigger the indication unit 60 to output at least one indication of whether the fluid is contaminated. The memory 30 can comprise at least one computer program product that can comprise machine-readable instructions which can be provided to and executed by the processing unit 40 for at least one of the following: comparing the reference data set with the measured data set, triggering the measuring device 50 to perform a measurement, triggering the measuring device 50 to provide the raw measured data 15 and/or the measured data set 55, receiving raw measure data 35 from the memory 30, receiving the next or following machine-readable instruction(s) from the memory 30, sending and storing data to the memory 30, triggering the indication unit 60 to output at least one indication of whether the fluid is contaminated, performing the method discussed above with reference to FIG. 1, performing at least some of the steps of the method discussed above with reference to FIG. 1 or any combination thereof. As it will be understood, the method discussed above with reference to FIG. 1 can in the form of a computer implemented method and/or a computer program product and/or multiple computer program products.

Referring simultaneously to FIGS. 1 and 2, the method illustrated in FIG. 1 carried out by the system of FIG. 2 will be described.

In a step S1, the method may comprise providing to a memory component 30 a reference data set 35 related to a reference composition of the fluid. Further, in step S1 the method can comprise storing the reference data set 35 in the memory component 30. In addition, in step 51 the method can comprise providing the reference data set 35 from the memory component 30 to the processing unit 40. That is, in general, step S1 may comprise providing the reference data set 35 to the processing unit 40.

In some embodiments, a plurality of reference data sets 35 can be stored in the memory component 30. Each of the plurality of reference data sets 35 can preferably be labeled, i.e. associated with metadata. This can facilitate differentiating the reference data sets 35 from each other and/or identifying the reference data sets 35. In such embodiments, the method can comprise selecting one of the reference data sets 35 (e.g. based on the metadata) and provide the selected reference data set 35 to the processing unit 40.

In a step S2 the method can comprise the measuring device 50 generating the measured data set 55 and providing the measured data set 55 to the processing unit 40. Alternatively, in step S2, the method can comprise the measuring device 50 obtaining the raw measured data 15 and providing the raw measured data 15 to the processing unit 40. Further, in step S2 the processing unit can process the raw measured data 15 to generate the measured data set 55. Step S2 can further comprise the processing unit 40 triggering and/or controlling the measuring device 50 to perform the measurement for generating the raw measured data 15 and/or the measured data set 55.

In step S3, the processing unit 40 can compare the measured data set 55 with the reference data set 35. For example, the processing unit 40 can process the measured data set 55 and the reference data set 35 and can calculate a distance metric indicating the similarity (or dissimilarity) between the two data sets.

In step S4, based on the comparison the processing unit 40 can generate the determination for contamination 45 of the fluid in the fluid container 10.

In step S5, the method can comprise the indication unit 60 providing an indication of the determination for contamination. Step S5 may further comprise the processing unit 40 triggering and/or controlling the indication unit 60 to provide an indication of the determination for contamination of the fluid in the fluid container 10.

The method and system for detecting contamination of a fluid in a fluid container can be particularly advantageous for use in a mobile inhaler, such as, an e-cigarette. They can be particularly advantageous for informing a user of the mobile inhaler when the fluid contained in the mobile inhaler that the user intends to inhale is contaminated. Thus, the method and the system of the present invention prevents or at least reduces the risk of a user of a mobile inhaler inhaling contaminated fluids which can be hazardous to the health of the user of the mobile inhaler.

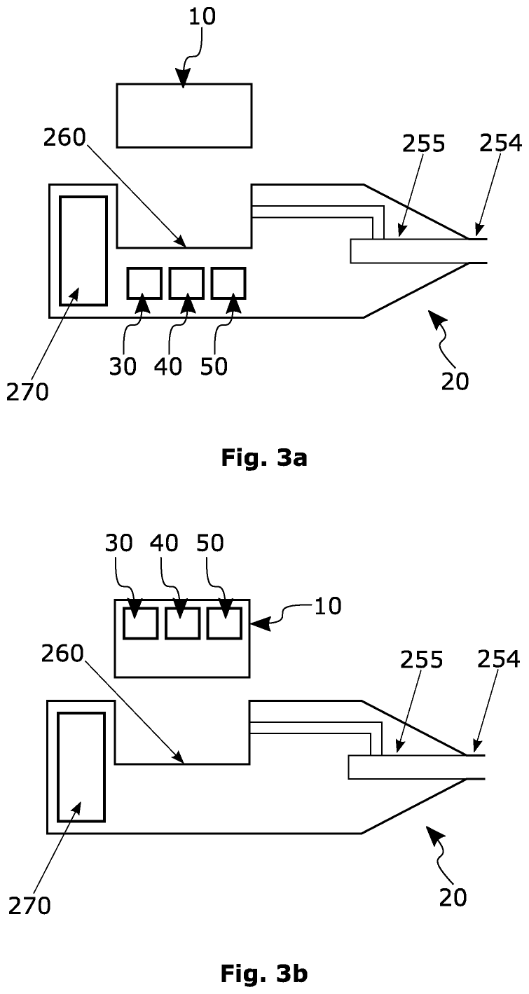

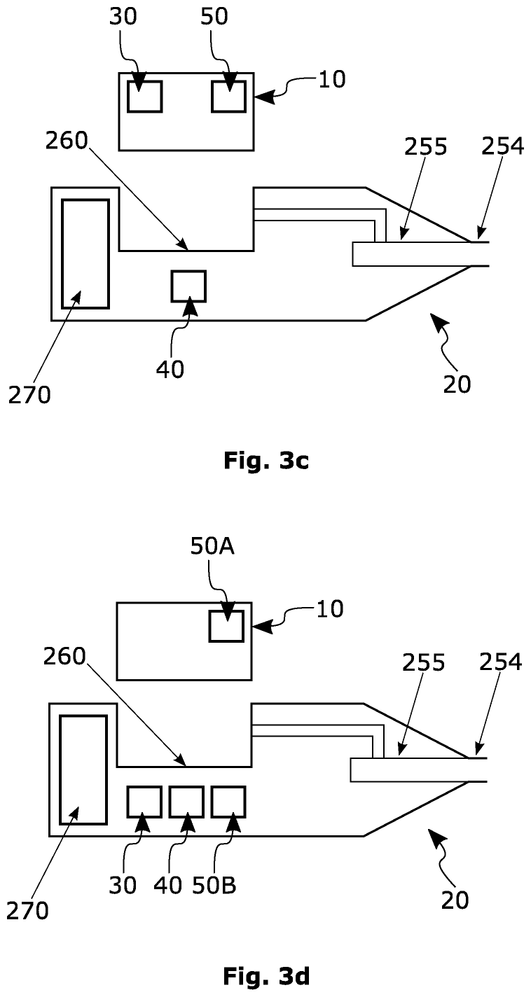

In FIGS. 3a to 3d, different embodiments of a mobile inhaler 20 and a respective fluid container 10 are illustrated.

The mobile inhaler 20 can comprise a mouth piece 254 and a canal 255. The mouth piece 254 can be configured to be brought into contact with a user of the mobile inhaler 20. The canal 255 is connected in one of its endpoints to the mouth piece 254 and on the other endpoint with a container receiving component 260 of the mobile inhaler 20. The canal 255 can be configured to guide a fluid (e.g. vapor) the canal the fluid container 10 positioned in the container receiving component 260 to the mouthpiece 254. Although the mobile inhaler 20 is illustrated with one canal 255, it will be noted that the mobile inhaler 20 can comprise a plurality of canals 255. This is particularly advantageous when multiple fluid container 10 can be attached to the mobile inhaler 20 and/or when the fluid container 10 can comprise a plurality of separate reservoirs which can be filled with fluid, potentially different fluids.

In addition, the mobile inhaler 20 can comprise an energy storage component 270, such as, a battery 270. The energy storage component 270 may be single or plural. The energy storage component 270 can particularly be advantageous for energizing a vaporizing component, typically comprised by mobile inhalers.

The above is a general illustration of a mobile inhaler 20. It will be noted that the mobile inhaler may comprise further components.

Furthermore, it will be noted that the fluid container 10 can be a replaceable component of the mobile inhaler 20. That is, the mobile inhaler 20 and the fluid container 10 can be configured to be attached to each other in a releasable manner. That is, the fluid container 10 can be in a fastened state and in unfastened state relative to the mobile inhaler 20. In the fastened state, the mobile inhaler 20 and the fluid container 10 can maintain their relative position. In the unfastened state, the fluid container 10 can be removed from the mobile inhaler 20. The fluid container 10 can be brought from the unfastened state to the fastened state with a fastening action, such as, clipping and/or screwing. Further, the fluid container 10 can be brought from the fastened state to the unfastened state with an unfastening action, such as, unclipping and/or unscrewing. If the fluid container 10 and the mobile inhaler 20 are configured to be releasably connected with each other, then during the fastening and unfastening actions the mobile inhaler 20 or the fluid container 10, particularly the mobile inhaler 20, cannot be damaged.

Alternatively, the fluid container 10 and the mobile inhaler 20 can be attached in a non-releasable (i.e. non-detachable) manner. That is, the mobile inhaler 20 and the fluid container 10 may not be separated, without a forcing action which can damage the mobile inhaler 20 and the fluid container 10.

The features discussed below, can be applied to both of these embodiments, that is, when the fluid container 10 can be a replaceable component of the mobile inhaler 20 and when the fluid container 10 and the mobile inhaler 20 can be attached in a non-releasable (i.e. non-detachable) manner.

In some embodiments, the memory component 30, the measuring device 50 and the processing unit 40 (discussed with reference to FIG. 2) can be provided internal to the mobile inhaler 20 and/or fluid container 10, as depicted by the different embodiments of FIGS. 3a to 3d. More particularly, in some embodiments the mobile inhaler 20 can further comprise the memory component 30, the measuring device 50 and the processing unit 40. An example of such embodiments is illustrated in FIG. 3a, wherein the memory component 30, the measuring device 50 and the processing unit 40 are disposed in a mobile inhaler 20.

In such embodiments, the mobile inhaler 20 and/or the fluid container 10 and/or the measuring device 50 can be configured to allow the measuring device 50 to perform a measurement for generating raw measured data 35 and/or measured data set 55, as discussed with reference to FIG. 2. For example, the mobile inhaler 20 and/or the fluid container 10 and/or the measuring device 50 can be configured to allow the measuring device 50 to send and/or receive a measuring signal to/from the fluid container 10. In a particular embodiment, the fluid container 10 may comprise one or more connectors (not shown) wherein the measuring device 50 can be connected with the fluid container 10 or a component of the fluid container 10.

Alternatively, as illustrated in FIG. 3b, the memory component 30, the measuring device 50 and the processing unit 40 can be provided internal to the fluid container 10. That is, the memory component 30, the measuring device 50 and the processing unit 40 can be disposed in the fluid container 10.

Alternatively, as illustrated in FIG. 3c, the memory component 30 and the measuring device 50 can be provided internal to the fluid container 10 and the processing unit 40 can be provided external to the fluid container 10 and internal to the mobile inhaler 20. In such embodiments, the measuring device 50 and the processing unit 40 can be configured such that the measuring device 50 can provide data to the processing unit 40. Additionally, the mobile inhaler 10 and/or the fluid container 40 can be configured to facilitate the measuring device 50 providing data to the processing unit 40. Such embodiments, can be particularly advantageous in embodiments wherein the mobile inhaler 20 requires a processing unit 40 for other functionalities.

Alternatively, in some embodiments, the measuring device 50 can comprise a fluid container measuring device portion 50A and a mobile inhaler measuring device portion 50B. The fluid container measuring device portion 50A can be provided internal to the fluid container 10. The mobile inhaler measuring device portion 50B can be provided external to the fluid container 10 and internal to the mobile inhaler 20. That is, the measuring device 50 can be provided in part to the fluid container 10 and to the mobile inhaler 20. For example, the fluid container measuring device portion 50A can comprise at least one sensor (not shown) of the measuring device 50. Further, the mobile inhaler measuring device portion 50B can comprise processing or pre-processing means (not shown) for processing or pre-processing the sensor data (e.g.

a micro-controller, processor). The mobile inhaler measuring device portion 50B may comprise data transmission components (not shown) for facilitating the provision of raw measurement data 35 (see FIG. 2) or measurement data set (see FIG. 2) to the processing unit 40. The mobile inhaler measuring device portion 50B, may also comprise signal generators and receivers that can facilitate sending and/or receiving a measuring and/or power signal to/from the fluid container measuring device 50A.

On the other hand, in embodiments wherein the measuring device 50 can comprise a fluid container measuring device portion 50A and a mobile inhaler measuring device portion 50B, the memory component 30 and the processing unit 40 can be provided either internal to the mobile inhaler 20 and external to the fluid container 10, as depicted in FIG. 3d, or internal to the fluid container 10.

In addition, the indication unit 60 (shown in FIG. 2) can be provided in the fluid container 10 and/or the mobile inhaler 20. Preferably, the indication unit 60 can be provided on an outer surface of the fluid container 10 and/or mobile inhaler 20, such that, the indication unit 60 can be visible from outside the fluid container 10 and mobile inhaler 20. For example, a user of the mobile inhaler 20 can see the indication unit 20. This is particularly required and advantageous when the indication unit 20 provides a visual indication (e.g. the indication unit 20 comprises a LED or display).

In some embodiments, it can be advantageous to provide the memory component 30 to the fluid container 10. This can be particularly advantageous if the fluid container 10 is configured to be replaceable. Thus, depending on the fluid that can be contained on the fluid container 10, the memory component 30 comprised by the fluid container 10 can store a reference data set related to the reference composition corresponding to the fluid in the fluid container. As different fluid container 10 provide may contain different fluids, providing the memory component 30 to the fluid container 10 facilitates providing a reference data set corresponding to the fluid in the fluid container 10.

Put simply, in embodiments wherein different fluids can be comprised by a fluid container 10 and for each fluid a corresponding reference data set is relevant a matching between the respective fluid comprised in the fluid container 10 and the reference data set corresponding to the fluid in the fluid container 10, may be required. In some embodiments, said matching can be facilitate or provided by providing the memory component 30 on the fluid container 10, wherein the memory component 30 stores therein the reference data set that corresponds to the fluid in the fluid container 10.

Alternatively, and as discussed, the memory component 30 can be provided external to the fluid container 10 and internal to the mobile inhaler 20. In such embodiments, the memory component 30 may store one or more reference data sets. The one or more reference data sets stored in the memory component 30 may relate to one or more fluids that are allowed to be contained in the fluid container 10. In such embodiments, the measurement data set can be compared with each of the reference data sets stored in the memory component 30. If it can be determined that the measurement data set is similar or identical to at least one of the reference data sets, then it can be determined that the fluid in the fluid container 10 is not contaminated. Otherwise, it can be determined that the fluid in the fluid container 10 is contaminated.

In some embodiments, the reference data sets can be stored in the memory component 30 with a respective unique ID. This is particularly advantageous if multiple reference data sets are stored in the memory component 30. The unique ID can further be provided to the fluid container 10 and can be used to uniquely identify the fluid that is contained in the fluid container 10 and the corresponding reference data set. The unique ID can for example be provided in a machine-readable format, which the mobile inhaler 20 can obtain (i.e. “read”) with a scanning device (not shown). Thus, by obtaining the unique ID from the fluid container 10, the mobile inhaler 10 can match the fluid in the fluid container 10 with the corresponding reference data set. This is particularly advantageous in embodiments wherein the fluid container 10 is replaceable and cannot be refilled.

In the above the memory component 30 was described as comprising an electronic storage device 30. Alternatively or additionally, in some embodiments, the memory component 30 may comprise an optical label, preferably a machine-readable optical label, such as, a barcode and/or a QR code. The optical label may comprise information that can be related to the reference data set, such as, a unique ID assigned to the reference data set or to the fluid that the reference data set may relate to. Additionally or alternatively, the optical label may comprise the reference data set. Furthermore, in such embodiments, an optical reader (not shown) may be provided. The optical reader, which can also be referred to as a barcode reader, barcode detector, scanner, QR code reader, QR code detector, can be configured to extract information from the optical label, such as, by identifying a code in the optical label and decoding it to obtain the information. Thus, information related to the measurement data set and/or the measurement data can be obtained from the optical label utilizing the optical reader. The obtained data from the optical label can further be stored in the memory component 30 and/or provided to the processing unit 40. The optical label can preferably be provided to the fluid container 10 and preferably on the outer surface of the fluid container 10. This can be advantageous as the reference data set can be provided for the respective fluid contained in the fluid container 10.

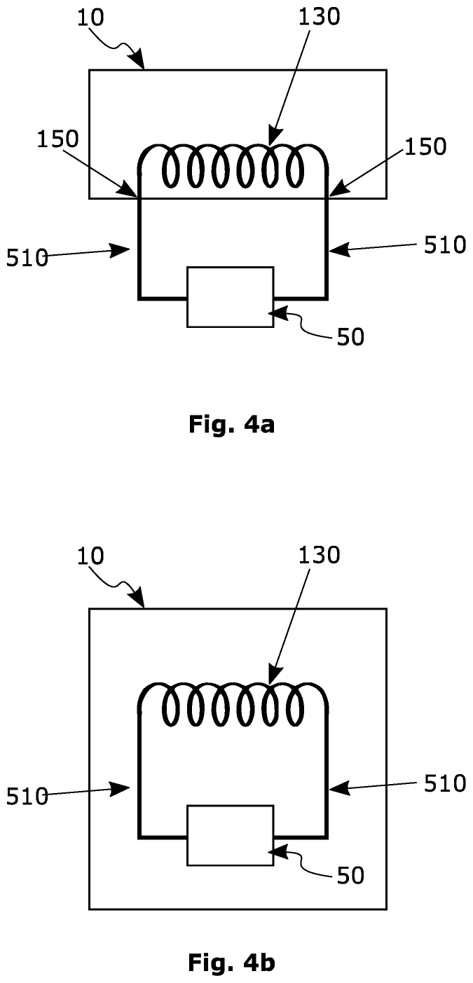

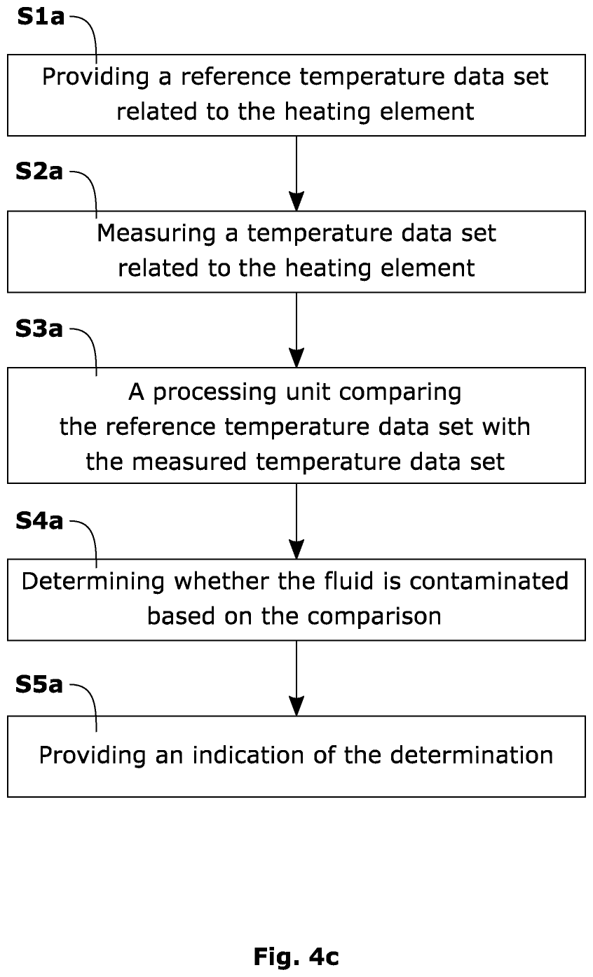

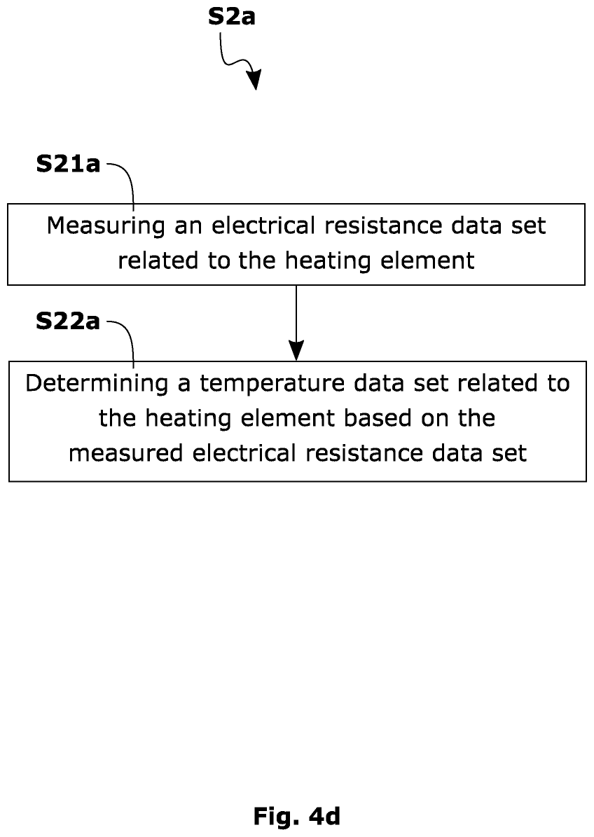

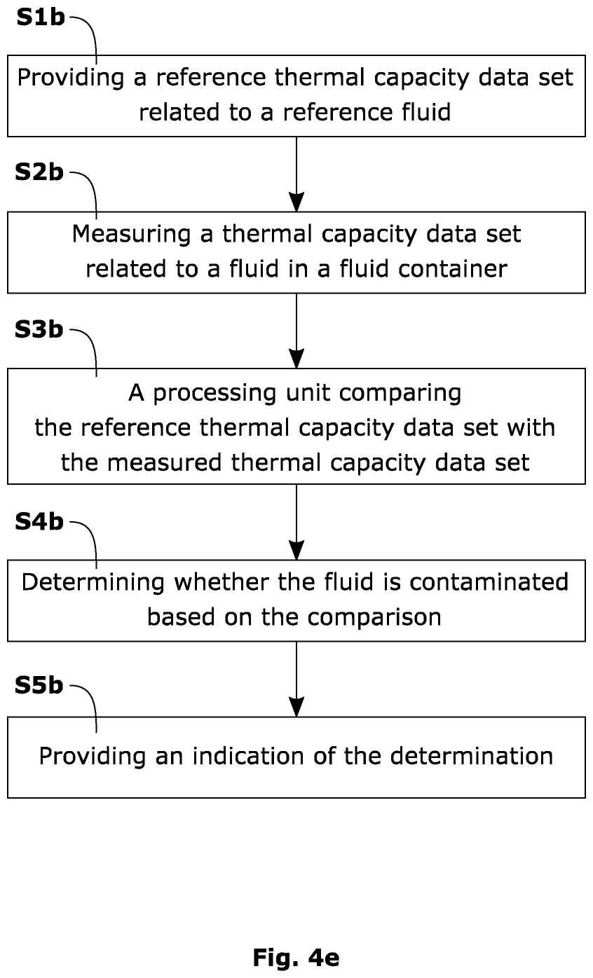

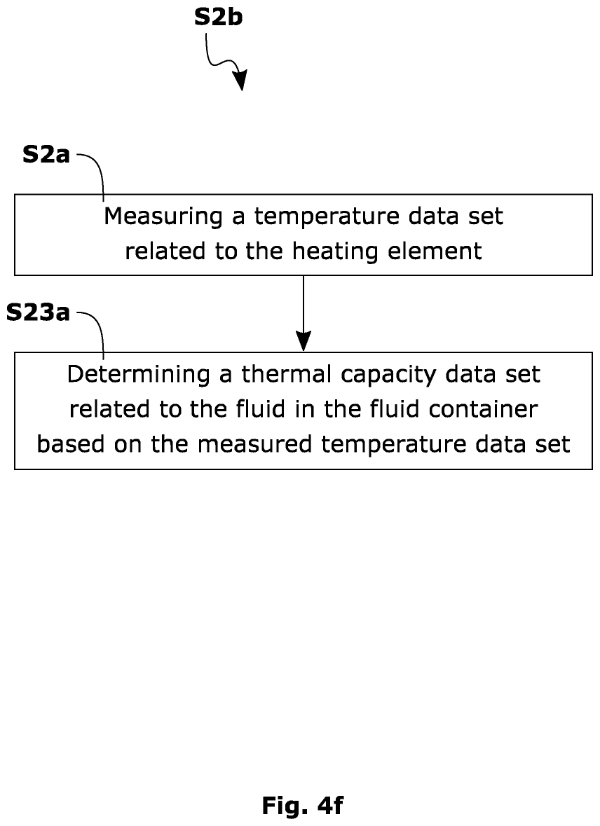

In FIG. 4a, an embodiment of a measuring device 50 and a fluid container 10 are illustrated. The measuring device 50 and the fluid container 10 can be part of the system illustrated in and discussed with reference to FIG. 2. However, the other components of the system, such as, the memory component 30 and the processing unit 40, are omitted not to overload the figure.

In the depicted embodiment, the fluid container 10 can further comprise a heating element 130. The heating element 130, which can also be referred to as a vaporizer 130 can be configured to generate heat and deliver the heat to the fluid contained in the fluid container 10. The heating element 130 may be configured to provide electrical resistance to an electric current that can pass through the heating element 130. For example, the heating element 130 may comprise a two-terminal electrical component that can provide electrical resistance to an electric current that can pass between the two terminals. The heating element 130 may typically comprise a resistor and/or inductor with a non-zero resistance.

At least two connectors 150 or ports 150 can be provided on the fluid container 10. The connectors 150 can facilitate the connection of an external device with the heating element 130. In embodiments wherein the heating element 130 comprises at least one two-terminal electrical component, such as, a resistor or an inductor, then two respective connectors 150 can be provided for each two-terminal electrical component or two connectors 150 can be provided for all the two-terminal electrical components comprised by the heating element 130.

Further, the signal guiders 510 can be provided. The signal guiders 510 can be connected in one end to a connector 150 (i.e. to the heating element 130) and on the other end to the measuring device 50. For each connector 150 a respective signal guider 510 can be provided connecting each connector 150 to the measuring device 50.

Although not shown in the figures, the heating element 130 can further be connected with an energy storage component, such as, the energy storage component 270 illustrated in FIGS. 3a to 3d. The energy storage component can be used to provide energy to the heating element 130 for generating heat. The energy storage component can also be used by the measuring device 50 for generating the measuring signal.

That is, the heating element 130 can be provided with two electrical currents. A first current, referred to as a power current, can be provided to the heating element 130 such that heat can be generated on the heating element 130. A second current, referred to as a measuring current or measuring signal, can be provided to the heating element 130 while the measuring device 50 performs a measurement (i.e. during step S2, see page 1). Both, the power current and the measuring signal can generate from the energy storage component. However, typically the power current can comprise a higher power compared to the measuring signal. Moreover, the two currents can undergo different circuits before being provided to the heating element 130.

In some embodiments, the power current can be provided directly from the battery storage component to the heating element 130, i.e. respective signal guiders (not shown) can connect the heating element 130 to the battery storage component directly. Alternatively, a power regulating circuit (not shown) can be provided between the battery storage component and the heating element 130. The power regulating circuit can be configured to adjust the power current that is provided to the heating element 130. For example, the power regulating circuit may be configured to provide an alternating power current to the heating element 130, such as, a pulse-width-modulated power current. A pulse-width-modulated power current can be particularly advantageous as, by adjusting the width of the pulse, also the power provided to the heating element 130 can be adjusted and thus, the amount of heat generated by the heating element 130.

The measuring signal can be provided to the heating element 130 through the measuring device 50. This can allow the measuring device 50 to “know” the properties of the measuring signal provided to the heating element 130. Furthermore, the measuring device 50 can be configured to provide to the heating element 50 a measuring signal which properties (e.g. amplitude as a function of time) have a low deviation from what they are intended to be (i.e. from what the measuring device “knows”). This can increase the accuracy of the measurement performed by the measurement device.

In some embodiments, the measuring signal and the power signal can be provided during the same period of time and out of phase each other to the heating component 130. For example, the measuring signal can be provided during the of cycles of a pulse-width-modulated power current. More generally, the power current can be provided to the heating element 130 in on and off cycles, e.g. as a square wave. During the on cycles the power current has a non-zero amplitude and as such the heating element 130 is heated during the on cycles. During the off cycles, the power current has a zero amplitude, i.e. no power current passes through the heating element 130. During the off cycles, the measuring signal can be provided to the heating element 130. Thus, only the measuring signal current can pass through the heating element 130 during the off cycles of the power current. Thus, an accurate measurement can be performed as the measuring signal is not interfered by the power current.

Alternatively, the power current can be used as a measuring signal as well. That is, the measuring device 50 can use the power current for performing the measurement. However, this may not provide accurate measurements, as typically the power current is not generated in an accurate way. The measuring signal, which can comprise a smaller power than the power current, can be generated more accurately and thus can facilitate a more accurate measurement. However, using a measuring signal instead of the power current may require that the power current is provided to the heating element in cycles, as discussed above.

FIG. 4b, depicts a similar embodiment to the one illustrated in FIG. 4a; however, the measuring device is provided internal to the fluid container 10. As such, also the signal guiders 510 can be provided internal to the fluid container 10 and the connectors 150, depicted in FIG. 4a, may not be required in the embodiment of FIG. 4b. Alternatively, due to the close proximity between the heating element 130 and the measuring device 50, the signal guiders 510 may not be required and instead the measuring device 50 and the heating element 130 can be directly connected with each other. The other features discussed with reference to the embodiment of FIG. 4a, can also be applied to the embodiment illustrated in the FIG. 4b.

With reference to FIGS. 4a to 4d, methods for detecting contamination of a fluid in a fluid container using the embodiments illustrated in FIGS. 4a and 4b, will be discussed. More particularly, FIG. 4c illustrates an embodiment of the method depicted in and discussed with reference to FIG. 1. To indicate the correspondence between the steps of the method illustrated in FIG. 1 and the steps of the method illustrated in FIG. 4c, the steps of the method in FIG. 4c are assigned with the same referrals as the steps illustrated in FIG. 1 by adding the postfix “a” to each corresponding referrals from FIG. 1.

The method discussed, in FIG. 4c is based on the rationale that different fluids (in general different materials) can comprise different thermal conductivities. That is, each material can comprise its specific thermal conductivity. Thus, changing the composition of a material can change the thermal conductivity. To put it simply, each material comprises its respective ability to conduct (i.e. transfer, provide or receive) heat. Thus, different material can transfer heat at different rates. The higher the thermal conductivity of a material the higher the rate at which the material conducts heat.

Based on this rationale, different fluids in a fluid container 10, can have different thermal conductivities. Changing the composition of the fluid will also change the thermal conductivity of the fluid. In other words, different fluids can receive heat from the heating element 130 at different rates. In addition, the rate at which heat is conducted from the heating element 130 to the fluid in the fluid container 10 can be reflected on the temperature of the heating element 130 during the heating time. For example, a fluid with a high thermal conductivity can cause the heating element 130 to heat more slowly compared to fluid with a low thermal conductivity. The reason for this is that the fluid with the high thermal conductivity can receive heat from the heating element 130 faster compared to the fluid with the low thermal conductivity. As such, for the same amount of time the fluid with the high thermal conductivity can draw more heat from the heating element 130.

Furthermore, the thermal conductivity of a material typically depends on the temperature and phase of the material. Thus, as the fluid's temperature increases (during the heating process) the thermal conductivity of the fluid changes. The thermal conductivity of different fluids can show different behaviors of the thermal conductivity over the time the fluid is heated.

Thus, by measuring the temperature of the of the heating element 130, a property of the fluid in the fluid container, in this case, the thermal conductivity of the fluid, can be inferred.

Thus, in a step S1a, the method for detecting contamination can comprise providing a reference temperature data set related to the heating element 130. That is, the reference data step can comprise a reference temperature data set. The reference temperature data set may comprise a plurality of temperature measurements of the heating element 130 brought into contact with a reference fluid composed according to the reference composition. The reference fluid, as discussed, is characterized by a specific thermal conductivity, or more precisely, by a specific behavior of the thermal conductivity as a function of temperature. Due to this, the temperature of the heating element 130 shows a respective behavior as a function of time, during which the power current is provided to the heating element 130, which depends on the thermal conductivity of the reference fluid. Thus, the reference temperature data set can be generated then provided in step S1. The reference temperature data set can comprise a time series of the temperature of the heating element.

As discussed, the reference data set can be provided to a memory component.

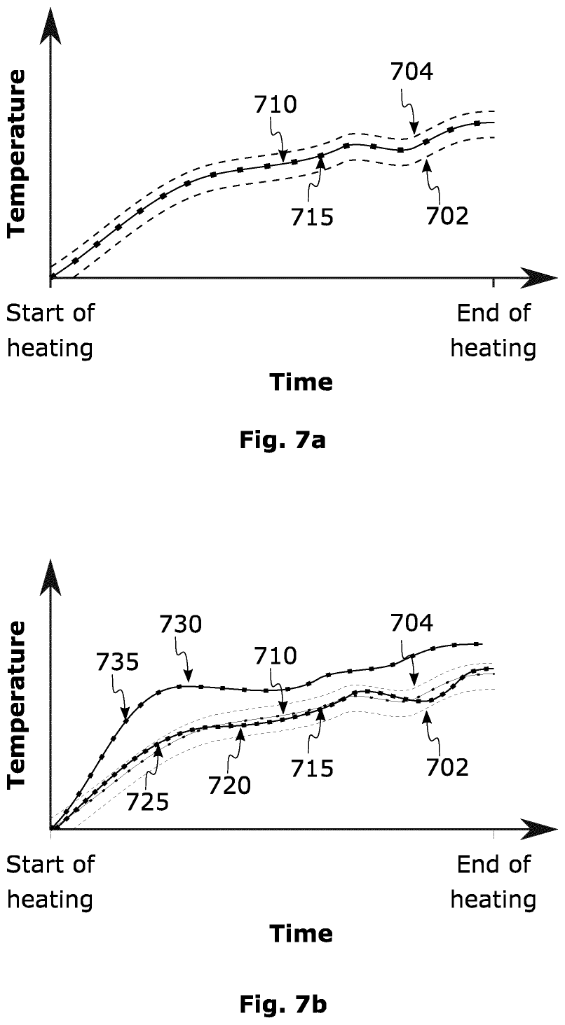

FIG. 7a, illustrates an exemplary reference data set 710. The reference data set 710 is illustrated by plotting it in a graph with time and temperature axis. The reference data set 710 can comprise a plurality of reference data points 715, which can correspond to temperature measurements 715 of the heating element 130. In the provided example, the temperature measurements 715 are performed in periodic manner during the time between the start of heating of the heating element 130 and end of heating of the heating element 130.

In addition, and as depicted in FIG. 7a, an upper bound 704 and a lower bound 702 can be provided with the reference data set. The upper bound 704 and the lower bound 702 can specify a region around the reference data set. All temperature data sets that can lie within the said region, i.e. between the upper and lower bound can be considered to be the same with the reference data set.

The upper and lower bound 704, 702 can also be provided with a respective upper threshold and lower thresholds. The upper and lower thresholds can specify a maximum deviation from the reference data set in the respective direction, for a temperature data set to be considered not different from the reference data set. In the example of FIG. 7a, the upper and lower thresholds are depicted constant over time. However, the person skilled in the art will understand that the upper and lower thresholds can change as a function of time and/or as a function of temperature. Moreover, the upper and lower thresholds can be equal to each other or different from each other.

In a step S2a, the method can comprise measuring a temperature data set related to the heating element 130. That is, the measurement data step can comprise a temperature data set. In this step, the fluid under test (contained in the fluid container) for contamination is brought into contact with the heating element 130. Thus, the temperature of the heating element 130 will depend on the thermal conductivity of the fluid under test.

FIG. 7b, illustrates two exemplary temperature data sets 720 and 730, with respective measured data points 725 and 735, obtained by measuring the temperature of the heating element 130 when brought into contact with two respective and different fluids. Similar to FIG. 7a, the temperature data set 720 and 730 are illustrated by plotting them in a graph with time and temperature axis. For comparison, the reference data set 710 with the upper and lower bounds 704, 702 is also provided.

Further, in a step S3a the method can comprise a processing unit (e.g. the processing unit 40 discussed in FIG. 2) comparing the reference temperature data set with the measured temperature data set. Next, similar to the method of FIG. 1, in a step S4a, the method can comprise determining whether the fluid is contaminated based on the comparison and in a step S5a providing an indication of the determinations.

Step S3a and S4a will be further described with reference to the examples of FIGS. 7a and 7b. As indicated by the temperature data set 720, under the presence of the corresponding fluid the temperature of the heating element 130 comprises a similar behavior compared to when the heating element 130 is in the presence of the reference fluid. Furthermore, as the temperature data set 720 is between the upper bound 704 and lower bound 702, it can be determined that it does not differentiate from the reference temperature data set 710. As such, the tested fluid can be determined to not differentiate from the reference fluid, i.e., based on the result of the comparison it can be determined that the tested fluid is not contaminated.

On the other hand, the temperature data set 730 indicates that the heating element 130 is heated faster compared to when the other exemplary data sets were generated. It will be noted that for the sake of comparison during the generation of the reference data set (in step S1) and temperature data sets (in step S2), the heating element 130 has the same or similar properties (e.g. resistance) and the power current provided to the heating elements 130 is also the same or at least similar. As such, the reason for the heating element 130 to show different temperature behaviors during the heating time is due to the fluid that the heating element is in contact with. In the provided examples, it can be inferred that the fluid used during the generation of temperature data set 730 comprises smaller thermal conductivity compared to the other exemplary/reference fluids. Furthermore, as the temperature data set 730 comprises data points 735 outside the region defined by the upper and lower bounds 704, 702, the temperature data set 730 can be determined to be different from the reference temperature data set 710 and the respective tested fluid can be determined to be contaminated.

In some embodiments, further a threshold portion can be defined, which threshold portion can specify a maximum portion of measured data points that can be outside the upper and lower bounds 704, 702 for the measured data set to be determined as not different from the reference data set.

In some embodiments, the upper and lower bounds 704, 702 may not be provided and the measured data set is compared directly with the reference data set, rather than with the upper and lower bound. That is, in such embodiments the upper and lower thresholds are set to zero.

In some embodiments, the temperature of the heating element may be directly measured with a temperature sensor. That is, the measuring device 50 can comprise a temperature sensor configured to measure the temperature of the heating element 130.

Alternatively and as illustrated in FIG. 4d, the temperature of the heating element 130 can be measured indirectly by measuring the electrical resistance of the heating element in a sub-step S21a of step S3a and determining the temperature of the heating element based on the electrical resistance of the heating element in a sub-step S22a of step S2a. In such embodiments the heating element 130 can be configured such that its electrical resistance is dependent on temperature (e.g. similar to a thermistor).

Typically, for any material the electrical resistance changes depending on the temperature of the material. Furthermore, based on empirical data and/or material and/or size of the heating element 130, the dependence of the electrical resistance on the temperature of the heating element 130 can be determined.

As such, in some embodiments wherein a dependence (i.e. function) of the electrical resistance on the temperature of the heating element 130 is known or can be determined, the temperature of the heating element 130 can be determined by configuring the measuring device 50 to measure the electrical resistance of the heating element 130. For example, the measuring device 50 may comprise an ohmmeter.

In FIGS. 4e and 4f a yet further embodiment of the method illustrated in FIG. 1 is provided. To indicate the correspondence between the steps of the method illustrated in FIG. 1 and the steps of the method illustrated in FIG. 4ce the steps of the method in FIG. 4e are assigned with the same referrals as the steps illustrated in FIG. 1 by adding the postfix “b” to each corresponding referrals from FIG. 1.

In a step S1b, a reference thermal capacity data set related to a reference fluid can be provided. That is, the reference data set in some embodiments can comprise a reference thermal capacity data set. The reference thermal capacity data set can be measured using a fluid composed according to the reference composition and/or can be inferred based on the properties of the reference fluid. In some embodiments, the reference thermal capacity data set can be inferred from a reference temperature data set discussed in step S1a (see FIG. 4c).

In a step S2b, the method can comprise measuring a thermal capacity data set related to the fluid in a fluid container. As illustrated in FIG. 4f, the thermal capacity data set can be measured by measuring a temperature data set related to the heating element according to step S2a (also discussed with reference to FIGS. 4c and 4d) and then determining a thermal capacity data set related to the fluid in the fluid container based on the measured temperature data set.

Next, the method can comprise step S3b, wherein a processing unit can compare the reference thermal capacity date set with the measured thermal capacity data set, step S4b wherein it can be determined whether the fluid is contaminated based on the comparison and step S5b, wherein an indication for the determination can be provided.

In the above, the reference data set and the measured data set related to quantities of the form temperature of the heating element 130 as a function of time (FIGS. 4c, 4d, 7a and 7b) and thermal capacity of the fluid as a function of time (FIGS. 4e, 4f). The person skilled in the art will understand that the reference data set and the measured data set related to quantities such as, the temperature of the fluid as a function of time, temperature of the heating element as a function of the electrical charge provided to the heating element, temperature of the fluid as a function of the electrical charge provided to the heating element, thermal capacity of the fluid as a function of the temperature of the fluid, thermal capacity of the fluid as a function of the temperature of the heating element and thermal capacity of the fluid as a function of the electrical charge provided to the heating element.

In the embodiments illustrated in FIGS. 4a to 4f, contamination in a fluid can be determined based on temperature and/or resistance measurements performed on the heating element 130.

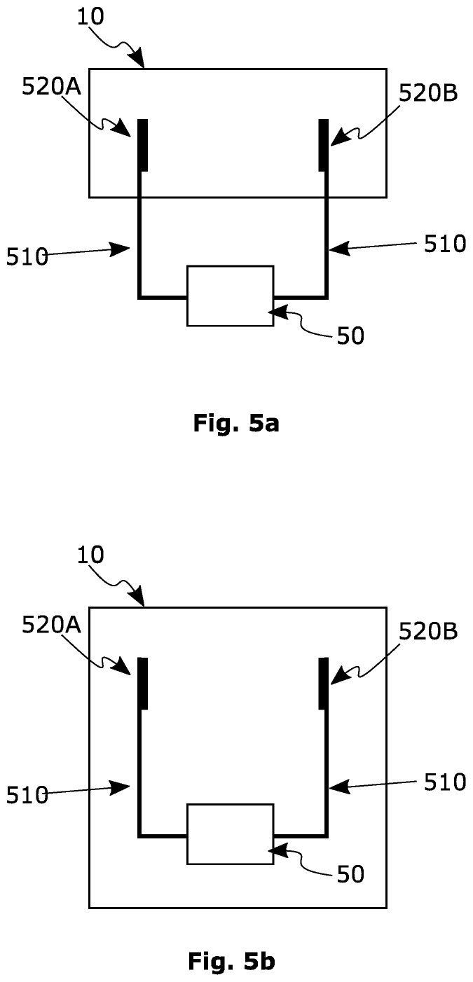

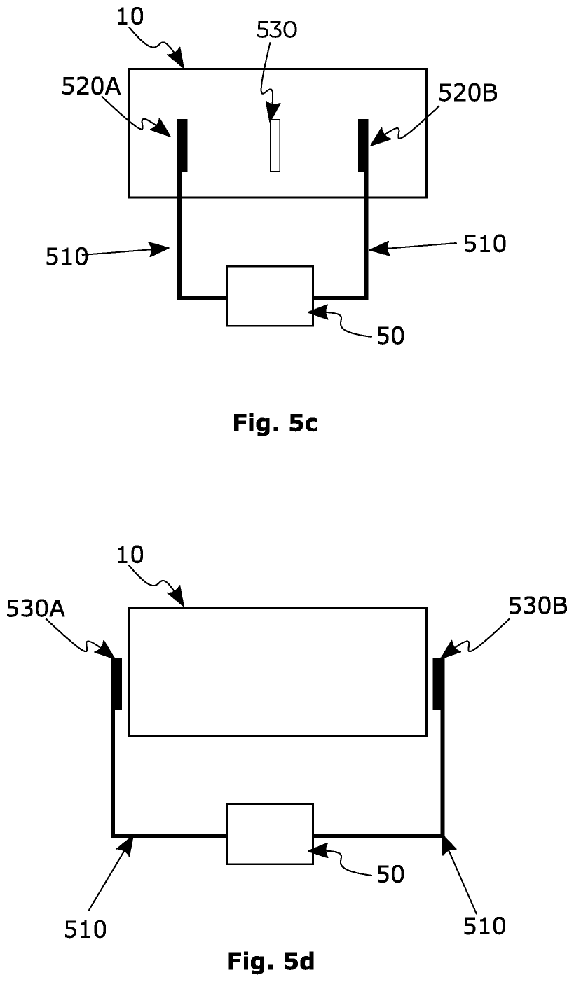

Alternatively, and as illustrated in FIGS. 5a and 5b, contamination in a fluid can be determined based on direct measurement of the fluid.

In FIGS. 5a and 5b, similar to the embodiments of FIGS. 4a and 4b, a fluid container 10 and a measuring device 50 are illustrated. In FIG. 5a, the measuring device 50 is provided external to the fluid container 10 and in FIG. 5b, the measuring device 50 is provided internal to the fluid container 10.

In addition, internally to the fluid container 10 a first measuring component 520A and a second measuring component 520B can be provided. The first and the second component 520A, 520B can also be referred to as a transmitting component 520A and receiving component 520B, respectively.

Both the transmitting component 520A and receiving component 520B can be connected to the measuring device with respective signal guiders 510. The signal guiders 510 can facilitate providing the measuring signal from the measuring device 50 to the transmitting component 520A and from the receiving component 52B to the measuring device. For example, the signal guiders 510 can comprise electrical wires and/or electrical cables. In addition, connectors (not shown) can be provided to facilitate the respective connection between the transmitting component 520A with the measuring device 50 and receiving component 520B with the measuring device 50.

The measuring signal can be provided to the transmitting component 520A from the measuring device 50. The measuring signal can then propagate through the fluid in the fluid container 10 and be received by the receiving component 520B. The measuring signal can then be provided to the measuring device 50 from the receiving component 520B.

During the propagation of the measuring signal through the fluid in the fluid container, the measuring signal can be affected (i.e. changed). This change can be detected by the measuring device 50 which can be configured to compare the measuring signal as generated (i.e. before the propagation through the fluid in the fluid container) and the measuring signal as received (i.e. after the propagation through the fluid in the fluid container).

Different fluids can cause different changes to the measuring signal. Changing the composition of a fluid can change the effect of the fluid on the measuring signal. Thus, by measuring and providing the effects of a reference fluid on the measuring signal, measuring the effects of a fluid under test on the measuring signal and comparing the two, contamination on the fluid container can be detected.

Thus, in some embodiments, the reference data set can comprise a difference between the measuring signal as generated (i.e. before the propagation through the reference fluid) and the measuring signal as received (i.e. after the propagation through the reference fluid). Correspondingly, the measured data set can comprise a difference between the measuring signal as generated (i.e. before the propagation through the fluid under test) and the measuring signal as received (i.e. after the propagation through the fluid under test).

Alternatively, the reference data set can comprise data related to the measuring signal as received after propagation through the reference fluid. Correspondingly, the measured data set can comprise the measuring signal as received after propagation through the reference fluid. In such embodiments, it may be required to use measuring signals with same properties when performing a measurement of the reference fluid and the fluid under test.

In some embodiments, the measuring signal can propagate through fluid as an electrical current. In such embodiments, the first component 520A and the second component 520B can comprise electrodes 520A, 520B. In such embodiments, the electrical resistance (or similarly the electrical conductivity) of the fluid can be measured. That is, the reference data set can relate to the electrical resistance or conductance of the reference fluid and the measured data set can relate to the electrical resistance or conductance of the fluid under test.

That is, the measuring device 50 can create a difference of electrical potentials between the electrodes 520A and 520B. This can generate a current flowing from one of the electrodes to the other. Based on the difference of electrical potentials between the electrodes 520A and 520B and by measuring the amplitude of the current flowing through the fluid from one of the electrodes to the other, the electrical resistance of the fluid can be measured.

The above can be performed for a reference fluid, i.e., a fluid composed according to the reference composition. Thus, a reference data set comprising the electrical resistance of the fluid can be generated. Measuring the electrical resistance of the reference fluid to generate the reference data set can be performed while the reference fluid comprises temperatures. For example, one measurement can be performed when the reference fluid is at room temperature, i.e., unheated. Further measurements can be performed while the reference fluid is heated. Furthermore, in addition to measuring the electrical resistance of the reference fluid, the temperature of the fluid can be measured. Thus, the reference data set can comprise data indicating the electrical resistance of the reference fluid as a function of its temperature.

Similarly, the electrical resistance of any fluid in a fluid container (i.e. the fluid under test) can be measured. Thus, a measured data set comprising the electrical resistance of the fluid under test can be generated. Measuring the electrical resistance of the fluid under test to generate the measured data set can be performed while the fluid under test comprises temperatures. For example, one measurement can be performed when the fluid under test is at room temperature, i.e., unheated, e.g. 18-25 degree Celsius. Further measurements can be performed while the reference fluid is heated. Furthermore, in addition to measuring the electrical resistance of the fluid under test, the temperature of the fluid can be measured. Thus, the measured data set can comprise data indicating the electrical resistance of the fluid under test as a function of its temperature.

Thus, contamination in a fluid can be detected if the electrical resistance of the fluid under test differs from the electrical resistance of the reference fluid.

In some embodiments, detecting contamination in a fluid can be based on the refractive index of the fluid. Refraction is the change in direction of a wave passing from one medium to another or from a gradual change in the medium. Typically, electromagnetic waves, such as, a beam of light, can be used to measure the refractive index of a fluid.

Measuring the refractive index of the fluid in the fluid container 10 can be performed with the embodiments illustrated in FIGS. 5a and 5b, wherein the transmitting component 520A and the receiving component 520B can be provided. To facilitate the measuring of the refractive index of the fluid in the fluid container 10, the transmitting component 520A can be an electromagnetic wave transmitter 520 (e.g. transmitting antenna 520A, laser 520A or LED 520A) and the receiving component 520B can be an electromagnetic wave receiver 520B or electromagnetic wave detector 520B, e.g., light sensor, optical sensor, image sensor. Preferably, the transmitting component 520A can be configured to emit an electromagnetic wave with a narrow beam-width, i.e. a high-directional electromagnetic wave. In a preferred embodiment the transmitting component 520A can be a laser 520A. A collimator lens may further be provided to narrow the beam of the transmitting component 520A (e.g. light source) to a predetermined and/or desired width.

On the other hand, the receiving component 520B can be configured to detect the electromagnetic wave emitted by the transmitting component 520A and further preferably indicate a position where the electromagnetic wave was received. For example, the receiving component 520B may comprise a flat surface (not shown) wherein a plurality of electromagnetic wave detectors is disposed, preferably, uniformly. Each electromagnetic wave detector can be configured to indicate when the electromagnetic wave is incident on the said electromagnetic wave detector. For example, under the influence of the incident electromagnetic wave, the electromagnetic wave detector may cause a respective capacitor to charge. Then, depending on the electromagnetic wave detector that were affected by the incident electromagnetic wave, the position of incidence of the electromagnetic wave can be determined.

Furthermore, to enable the measurement of the refractive index of the fluid in a fluid container, it may be required that the electromagnetic wave emitted by the transmitting component 520A passes through at least two different mediums, one of which being the fluid in the fluid container, before being received by the receiving component 520B. Furthermore, the refractive index of the other mediums may also be required to determine the refractive index of the fluid in the fluid container.

As illustrated in FIG. 5c, in some embodiments, at least one further component 530, which can be a passive component 530, and comprising a material different from the fluid in the fluid container 10 can be positioned between the transmitting component 520A and receiving component 520B. The passive component 530 can preferably be configured to allow a portion of the energy of the electromagnetic wave emitted by the transmitting component 520A to pass through it. For example, the passive component 530 may comprise a low reflection index of the electromagnetic wave. The passive component 530 may, for example, comprise a translucent material, such as, translucent plastic or glass. The passive component 530 may also comprise a chamber (not shown) which can be filled with air.

Alternatively, as illustrated in FIG. 5d, the transmitting component 520A and receiving component 520B can be provided inside a chamber 540. The chamber 540 can be configured such that a portion of the chamber can be filled with the fluid in the fluid container 10. Another portion of the chamber 540 can be filled with air. As such, the electromagnetic wave can at least pass through air and the fluid.

Alternatively still, as illustrated in FIG. 5d, at least one of the components 530A, 530B can be provided external to the fluid container 10. Furthermore, the fluid container 10 or at least a portion of the fluid container 10 can be configured to be translucent to the electromagnetic wave emitted by the transmitting component 530A. This can allow the emitted electromagnetic wave to pass through the surface of the fluid container 10 and be received by the receiving component 530B.

Thus, with the above embodiments illustrated in FIGS. 5a to 5d, depending on the fluid in the fluid container 10, the electromagnetic wave can follow a certain direction. Changing the fluid in the fluid container can change the direction that the electromagnetic wave can follow. Thus, the position where the electromagnetic wave is incident on the receiving component 520B can depend on the fluid in the fluid container. Thus, data related to the position where the electromagnetic wave is incident on the receiving component 520B can be obtained. Furthermore, they can be used to calculate a refractive index of the fluid in the fluid container.

The electromagnetic wave may comprise different spectrums. For example, the electromagnetic wave may comprise infra-red light and/or visible light. The position where the electromagnetic wave is incident on the receiving component 520B can depend on the spectrum of the electromagnetic wave. Data related to the position where the electromagnetic wave is incident on the receiving component 520B can be obtained for one or more spectrums and based thereon for each spectrum a respective refractive index can be obtained.

Thus, the refractive index or data related to the position where the electromagnetic wave is incident on the receiving component 520B can be obtained for a reference fluid, as discussed above. Hence, a reference data set can be generated. Similarly, the refractive index or data related to the position where the electromagnetic wave is incident on the receiving component 520B can be obtained for a fluid under test, as discussed above. Hence, a measured data set can be generated. Comparing the measured data set and the reference data set, it can be determined whether the refractive index of the fluid under test is different from the refractive index of the reference fluid. Based on this, it can be determined whether the fluid under test is contaminated.

Preferably, measurements related to the refractive index of a fluid can be performed while the fluid is motionless. For example, measurements related to the refractive index of the fluid in the fluid container 10 of a mobile inhaler 20 (see FIGS. 3a to 3d) can be performed while the mobile inhaler is not in use and motionless.

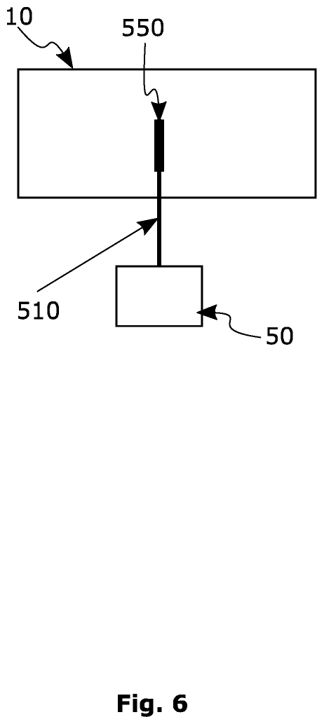

Alternatively or additionally to the embodiments of FIGS. 4a, 4b and 5a to 5d, a fluid sensor 550 can further be provided internal to the fluid container 10, as illustrated in FIG. 6. The fluid sensor 550 can further be connected with a respective signal guider 510 to the measuring device 50.

The fluid sensor 550 can be configured to measure one or more properties of the fluid in the fluid container 10. The fluid sensor 550 may comprise a thermometer 550 configured to measure a temperature of the fluid in the fluid container 10. Temperature data that can be collected using the thermometer 550 can be used in combination with the other data sets discussed in all the preceding embodiments.

Alternatively or additionally, the fluid sensor 550 may comprise a pH meter 550 configured to measure acidity or alkalinity of the fluid in the fluid container 10. In such embodiments, data collected using the pH meter 550 can be used to determine whether the acidity or alkalinity of a fluid under test is the same as the acidity or alkalinity of a corresponding reference fluid. This can then be used to determine whether the fluid is contaminated. Whenever a relative term, such as “about”, “substantially” or “approximately” is used in this specification, such a term should also be construed to also include the exact term. That is, e.g., “substantially straight” should be construed to also include “(exactly) straight”.

It should also be understood that whenever reference is made to an element this does not exclude a plurality of said elements. For example, if something is said to comprise an element it may comprise a single element but also a plurality of elements.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

Furthermore, reference numbers and letters appearing between parentheses in the claims, identifying features described in the embodiments and illustrated in the accompanying drawings, are provided as an aid to the reader as an exemplification of the matter claimed. The inclusion of such reference numbers and letters is not to be interpreted as placing any limitations on the scope of the claims.

1-15. (canceled)

16. A method for detecting contamination of a fluid in a fluid container, the method comprising:
providing a reference data set related to a reference composition of the fluid;
generating a measured data set related to an actual composition of the fluid in the fluid container;
a processing unit comparing the reference data set with the measured data set; and
determining whether the fluid is contaminated based on the comparison.

17. The method according to claim 16, wherein the method comprises generating the reference data set by measuring at least one of:
a physical property depending on the composition of a fluid composed according to the reference composition, the physical property comprising a thermal property, an electrical property, an acoustical property, a magnetic property, or an optical property;
a chemical property depending on the composition of the fluid composed according to the reference composition, the chemical property comprising composition, acidity, or alkalinity; or
any combination thereof.

18. The method according claim 16, wherein generating a measured data set comprises a measuring device measuting at least one of:
a physical property depending on the actual composition of the fluid, the physical property comprising a thermal property, an electrical property, an acoustical property, a magnetic property, or an optical property;
a chemical property depending on the actual composition of the fluid, the chemical property comprising composition, acidity, or alkalinity; or
any combination thereof.

19. The method according to claim 16, wherein a heating element is provided internal to the fluid container heating the fluid in the fluid container by generating heat.

20. The method according to claim 19, wherein:
providing a reference data set comprises providing a reference electrical resistance data set related to the heating element;
the reference electrical resistance data set comprises a plurality of reference electrical resistance values indicating the expected electrical resistance of the heating element if heating a fluid composed according to the reference composition;
generating a measured data set comprises generating a measured electrical resistance data set related to the heating element; and
the measured electrical resistance data set comprises a plurality of electrical resistance values indicating he electrical resistance of the heating element while heating the fluid in the fluid container,

21. The method according to claim 20, wherein:
generating a measured data set comprises a measuring device measuring at least one of:
a physical property depending on the actual composition of the fluid, the physical property comprising a thermal property, an electrical property, an acoustical property, a magnetic property, or an optical property;
a chemical property depending on the actual composition of the fluid, the chemical property comprising composition, acidity, or alkalinity; or
any combination thereof; and
generating a measured electrical resistance data set related to the heating element comprises the measuring device measuring the electrical resistance of the heating element while heating the fluid in the fluid container.

2. The method according to claim 19, wherein:
providing a reference data set comprises providing a reference temperature data set related to the heating element;
the reference temperature data set comprises a plurality of reference temperature values indicating the expected temperature of the heating element if heating a fluid composed according to the reference composition;
generating a measured data set comprises generating a measured temperature data set related to the heating element; and
the measured temperature data set comprises a plurality of temperature values indicating the temperature of the heating element while heating the fluid in the fluid container.

23. The method according to claim 22, wherein:
generating a measured data set comprises a measuring device measuring at least one of:
a physical property depending on the actual composition of the fluid, the physical property comprising a thermal property, an electrical property, an acoustical property, a magnetic property, or an optical property;
a chemical property depending on the actual composition of the fluid, the chemical property comprising composition, acidity, or alkalinity; or
any combination thereof; and
generating a measured temperature data set related to the heating element comprises at least one of:
the measuring device measuring the temperature of the heating element while heating the fluid in the fluid container; and
the measuring device measuring the electrical resistance of the heating element while heating the fluid in the fluid container and calculating a temperature of the heating element based on the measured resistance of the heating element.

24. The method according to claim 16, further comprising providing a first component and a second component at a distance from each other and internally to the fluid container.

25. The method according to claim 24, wherein:
the first component and the second component respectively comprise at least one electrode;
providing a reference data set comprises providing a reference fluid electrical resistance data set related to a fluid composed according to the reference composition;
the reference fluid electrical resistance data set comprises a plurality of reference fluid electrical resistance values indicating the expected electrical resistance of the fluid in the fluid container if composed according to the reference composition;
generating a measured data set comprises generating a measured fluid electrical resistance data set related to the fluid in the fluid container; and
the measured fluid electrical resistance data set comprises a plurality of fluid electrical resistance values corresponding to the electrical resistance of the fluid in the fluid container.

26. The method according to claim 24, wherein:
the first component emits a measuring signal and the second component receives the measuring signal after the measuring signal propagates through the fluid in the fluid container and at least one other medium;
the method further comprises providing a reference refractive index data set related to a fluid composed according to the reference composition, wherein the measured refractive index data set comprises at least one refractive index value each indicating an expected refractive index of the fluid in the fluid container if composed according to the reference composition; and
generating the measured data set comprises generating a measured refractive index data set related to the fluid in the fluid container, wherein the measured refractive index data set comprises at least one refractive index value indicating the refractive index of the fluid in the fluid container.

27. The method according to claim 26, wherein the measuring signal comprises an electromagnetic wave with a narrow beam-width.

28. The method according to claim 16, wherein:
the fluid container is part of a. mobile inhaler; and
the fluid comprises a liquid, a liquid solution, a gas, an aerosol, or a vapor used in a mobile inhaler.

29. The method according to claim 28, wherein the mobile inhaler comprises an e-cigarette.

30. The method according to claim 16, wherein the method is used to detect contamination of a fluid in at least one fluid container of a mobile inhaler.

31. A system configured to detect contamination of a fluid in a fluid container, comprising:
a fluid container configured to be at least partly filled with a fluid;
a memory component configured to store a reference data set related to a reference composition of the fluid;
a measuring device configured to generate a measured data set related to the composition of the fluid; and
a processing unit configured to:
compare the measured data set with the reference data set; and
determine based on the comparison whether the fluid is contaminated, wherein the system is configured to carry out the method according to claim 16.

32. A mobile inhaler comprising:
at least one fluid container configured to he at least partly filled with a fluid;
a memory component configured to store a reference data set related to a reference composition of the fluid;
a measuring device configured to generate a measured data set related to the composition of the fluid; and
a processing unit configured to:
compare the measured data set with the reference data set; and
determine based on the comparison whether the fluid is contaminated,
wherein the mobile inhaler is configured to carry out the method according claim 16.
